(19) United States
(12) Patent Application Publication
(10) Pub. No.: US 2026/0177723 A1
(43) Pub. Date: Jun. 25, 2026

(54) DOWNHOLE ACOUSTIC TOOL

(71) Applicant: Schlumberger Technology Corporation, Sugar Land, TX (US)

(72) Inventors: Hiroshi Nakajima, Sagamihara (JP); Toshihiro Kinoshita, Sugar Land, TX (US); Qingyan He, Sugar Land, TX (US); Haruhiko Masuda, Sugar Land, TX (US); Evgeniya Deger, Sugar Land, TX (US); Mizuki Yajima, Sagamihara (JP); Frank F. Espinosa, Titusville, NJ (US)

(21) Appl. No.: 18/987,144

(22) Filed: Dec. 19, 2024

(51) Int. Cl. G01V 1/52

(52) U.S. Cl. CPC G01V 1/523

(57) ABSTRACT

A downhole acoustic tool includes a tool body comprising a plurality of mass bodies connected via one or more spring bodies for forming an acoustic body. A plurality of acoustic receivers are positioned around the tool body on at least some of the plurality of mass bodies. The downhole acoustic tool includes an enclosure surrounding the tool body and the plurality of acoustic receivers, and an acoustic fluid contained within the enclosure, at least some of the acoustic fluid being positioned between an inner surface of the enclosure and the plurality of acoustic receivers.

### BACKGROUND OF THE DISCLOSURE

Wellbores may be drilled into a surface location or seabed for a variety of exploratory or extraction purposes. For example, a wellbore may be drilled to access fluids, such as liquid and gaseous hydrocarbons, stored in subterranean formations and to extract the fluids from the formations. Wellbores used to produce or extract fluids may be formed in earthen formations using earth-boring tools such as drill bits for drilling wellbores and reamers for enlarging the diameters of wellbores.

In many cases, measurement tools are implemented in wellbores for various purposes such as for surveying or evaluating a formation, wellbore, reservoir, etc. This may be achieved through the use of acoustic tools which transmit acoustic signals into a surrounding formation with acoustic transmitters positioned at one location in a wellbore and detect the acoustic signals from the surrounding formation with acoustic receivers positioned at other locations in the wellbore. Based on evaluating the returning signals, information about the surrounding formation can be inferred.

Many conventional acoustic tools suffer from signal interference associated with the acoustic receivers detecting the transmitted acoustic signals through tool itself, rather than through the formation, which may affect the reliability of acoustic data. Additionally, due to limitations in sizing and packaging, it may be difficult to obtain high-resolution acoustic data, with many acoustic receivers for example, in small tubular implementations. Further, acoustic tools may be flexible, presenting challenges associated with bending of the acoustic tool. Thus, improved acoustic tools overcoming these and other limitations may be advantageous.

### SUMMARY

In some embodiments, a downhole acoustic tool includes a tool body comprising a plurality of mass bodies connected via one or more spring bodies for forming an acoustic body. A plurality of acoustic receivers are positioned around the tool body on at least some of the plurality of mass bodies. The downhole acoustic tool includes an enclosure surrounding the tool body and the plurality of acoustic receivers, and an acoustic fluid contained within the enclosure, at least some of the acoustic fluid being positioned between an inner surface of the enclosure and the plurality of acoustic receivers.

In some embodiments, a downhole acoustic tool includes a tool body, at least one acoustic receiver positioned around an outer surface of the tool body, an enclosure surrounding the tool body and the at least one acoustic receiver, the enclosure including a plurality of interlocking sleeves that interlock at a plurality of sleeve interfaces, each sleeve interface of the plurality of sleeve interfaces being formed by, a first connector at a first interlocking sleeve of the sleeve interface, a second connector at a second interlocking sleeve of the sleeve interface configured to connect to the first connector, and a seal between the first interlocking sleeve and the second interlocking sleeve for sealing an inner volume of the enclosure, and an acoustic fluid contained within the enclosure, at least some of the acoustic fluid being positioned between an inner surface of the enclosure and the at least one acoustic receiver.

In some embodiments, a method of assembling a downhole acoustic tool, includes providing a tool body having at least one acoustic receiver positioned around an outer surface of the tool body, forming an enclosure around the tool body, including, positioning a first interlocking sleeve of a plurality of interlocking sleeves around the tool body at a longitudinal location of the tool body of a first acoustic receiver of the at least one acoustic receiver, positioning a second interlocking sleeve of the plurality of interlocking sleeves around the tool body, and connecting the first interlocking sleeve to the second interlocking sleeve by engaging a first connector of the first interlocking sleeve with a second connector of the second interlocking sleeve to seal an inner volume of the enclosure.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 illustrates an example of an acoustic tool that may be implemented in a wellbore for collecting acoustic data, according to at least one embodiment of the present disclosure;

FIGS. 2-1 and 2-2 illustrate examples of a tool body for an acoustic tool, according to at least one embodiment of the present disclosure;

FIG. 2-3 illustrates example acoustic properties of a tool body, according to at least one embodiment of the present disclosure;

FIG. 3-1 is a cross-section view and FIG. 3-2 is a partial cross-section view of an acoustic tool, according to at least one embodiment of the present disclosure;

FIG. 4-1 illustrates a perspective view of an acoustic tool, according to at least one embodiment of the present disclosure;

FIG. 4-2 illustrates a perspective view of the acoustic tool of FIG. 4-1 having acoustic sensing components positioned thereon;

FIG. 4-3 illustrates a cross-section view of an acoustic tool, according to at least one embodiment of the present disclosure;

FIGS. 5-1 and 5-2 illustrate side view of a section or unit of an acoustic tool, according to embodiments of the present disclosure;

FIG. 5-3 illustrates a side schematic view, FIG. 5-4 illustrates a side cross-section view, and FIG. 5-5 illustrates a side partial cutaway view of a portion of an acoustic tool, according to embodiments of the present disclosure;

FIG. 5-6 illustrates an example of an acoustic tool, according to at least one embodiment of the present disclosure;

FIG. 5-7 illustrates an example of an acoustic tool, according to at least one embodiment of the present disclosure;

FIG. 5-8 illustrates a cross-section view of a portion of an acoustic tool, according to at least one embodiment of the present disclosure;

FIG. 6-1 illustrates an example of an acoustic tool, according to at least one embodiment of the present disclosure;

FIG. 6-2 illustrates an example of an acoustic tool, according to at least one embodiment of the present disclosure;

FIG. 6-3 illustrates an example of an acoustic tool, according to at least one embodiment of the present disclosure;

FIG. 7-1 illustrates a perspective view of an enclosure for an acoustic tool, according to at least one embodiment of the present disclosure.

FIG. 7-2 illustrates a first perspective view and FIG. 7-3 illustrates a second perspective view of an interlocking sleeve of the enclosure of FIG. 7-1, according to at least one embodiment of the present disclosure;

FIG. 7-4 illustrates a side cross-sectional view and FIG. 7-5 illustrates a side cutaway view of the acoustic tool of FIG. 7-1, according to at least one embodiment of the present disclosure;

FIG. 8 illustrates a flow diagram for a method or a series of acts for assembling a downhole acoustic tool as described herein, according to at least one embodiment of the present disclosure; and

FIG. 9 is a side view of an acoustic tool, according to at least one embodiment of the present disclosure.

### DETAILED DESCRIPTION

This disclosure generally relates to acoustic tools for taking downhole acoustic measurements. The acoustic tools described herein include a tool body that comprises an acoustic body. The acoustic body includes mass body sections connected via spring body sections. The mass-spring distribution of the acoustic body facilitates attenuating acoustic signals that may tend to travel through the tool body. This may help to reduce or eliminate unwanted acoustic signals travelling through the body from interfering or affecting the detection of acoustic signals through the surrounding formation, increasing accuracy and reliability of the acoustic tool.

The acoustic tool may include a plurality of acoustic receivers positioned around a periphery or outer surface of the tool body. The acoustic receivers may be connected to the tool body in grooves formed around the tool body and may be contained within a same enclosure. This may be in contrast to other acoustic tools which may implement acoustic receivers package within individual enclosures. In this way, by positioning multiple acoustic receivers around the tool body and enclosing all the components together in an enclosure, the acoustic tool may accommodate more acoustic receivers, such as up to 8, at a given longitudinal position to increase the accuracy and resolution of the received acoustic data. The packaging of more acoustic receivers in this way may be especially advantageous for small-tubular applications, for example, wherein tubulars having a diameter of 6 inches or less (or 3 inches or less) can typically present significant challenges for including larger quantities of acoustic receivers around a circumference of the tool.

The tuned acoustic nature of the tool body may result in the tool body being somewhat flexible and/or susceptible to bending under loading. The single-enclosure design, however, may be somewhat rigid and inflexible such that bending of the tool body may cause the enclosure to fail. Acoustic tools described herein may be implemented with enclosures having a plurality of sections or units, which may provide protection from side loading while also accommodating flexure. For example, each unit may include a flexible member, such as a metallic bellows, which may permit bending and flexing of the tool body and may also contain an acoustic fluid within the enclosure. A protective member may be positioned around the flexible member and may provide strength and rigidity to withstand side loading that may tend to damage the flexible member. The multiple-unit configuration of the enclosure may also accommodate bends or doglegs in the acoustic tool.

The acoustic tool includes a transmitter portion. The transmitter portion may be equipped with one or more transmission amplifiers. The transmission amplifiers may be fin structures that extend from the tool body. The added mass and inertia of the transmission amplifiers may promote the acoustic energy generated by the acoustic transmitters travelling outward from the acoustic tool, for example, rather than being exited into the tool body. The fin structure may also facilitate focusing and/or isolating the transmitted acoustic signals in designated directions.

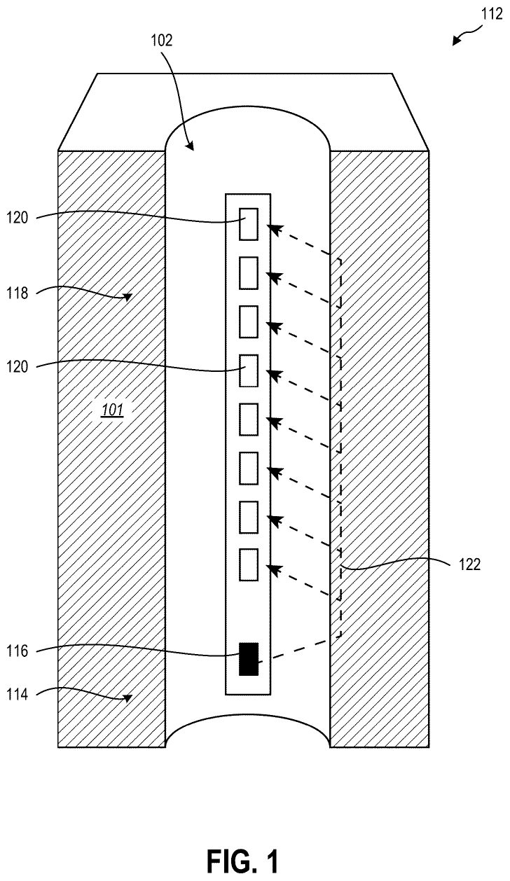

Additional details will now be provided regarding systems described herein in relation to illustrative figures portraying example implementations. For example, FIG. 1 illustrates an example of an acoustic tool 112 that may be implemented in the wellbore 102 for collecting acoustic data, according to at least one embodiment of the present disclosure. For example, the wellbore 102 may be a wellbore formed in a formation 101 as part of a downhole system or operation. For instance, the wellbore 102 may be formed to facilitate locating, accessing, and/or producing downhole resources such as oil, gas, water, geothermal energy, etc. The formation 101 may be a subsurface formation including one or more geological layers.

The acoustic tool 112 may be implemented in the wellbore 102 in order to facilitate surveying, evaluating, measuring, and/or characterizing one or more downhole components, formations, implements, etc. For example, the acoustic tool may be utilized to evaluate the surrounding formation 101, to evaluate cement of a casing of the wellbore 102, etc. The acoustic tool 112 may be conveyed and/or positioned within the wellbore 102 via a conveyance line such as a wireline or coiled tubing, for example, which may be controlled and administered via conveyance equipment at a surface of the wellbore 102. In this way, the acoustic tool 112 may be implemented in the wellbore for taking acoustic measurements which may facilitate a downhole operation.

The acoustic tool 112 may include a transmitter tool or transmitter portion 114 having one or more acoustic transmitters 116 and a receiver tool or receiver portion 118 having one or more acoustic receivers 120. The acoustic transmitters 116 and acoustic receivers 120 may be implemented as piezoelectric transducers (or any other suitable component) for converting electrical signals into acoustic energy (e.g., sound waves) and vice versa.

The acoustic tool 112 may operate by generating acoustic signals 122 and transmitting them into the surrounding formation 101. When the acoustic signals 122 are transmitted into the formation 101, they travel through the surrounding rock and fluids, reflecting and refracting depending on the material properties the acoustic signals 122 encounter. The reflected signals are then captured by the acoustic receivers 120, which convert the acoustic signals 122 back into electrical signals for analysis and for inferring information about the formation 101. For example, by analyzing the speed at which the acoustic signals 122 travel through the formation 101, as well as the amplitude and frequency of the received acoustic signals 122, information such as rock density, porosity, fluid content, and other mechanical properties can be inferred about the formation 101. In other cases, acoustic data may relay information about formation boundaries, fluid types, cement quality, and the identification and location of fractures. Further, acoustic tools like that described herein may be implemented for downhole imaging purposes for creating detailed images of borehole walls, detecting fractures, casing deformation, and other anomalies. The acoustic tool 112 may implement monopole signal transmission, dipole signal transmission, quadrupole signal transmission, and combinations thereof, for example, for taking details measurements of anisotropic and/or heterogenous formations.

Typically, the transmitter portion 114 and receiver portion 118 of the acoustic tool 112 are axially connected, either directly as shown in FIG. 1 or through an indirect connection by way of being included in the same tool string. Accordingly, the transmitter portion 114 and receiver portion 118 may be at least somewhat acoustically coupled, and in many cases, it can be challenging to prevent the acoustic signals 122 from at least somewhat traveling from the acoustic transmitter 116 to the acoustic receivers 120 through the acoustic tool 112 (e.g., through a tool body of the transmitter portion 114 and receiver portion 118) rather than wholly, substantially, or mostly through the formation 101. The acoustic signals 122 traveling through the acoustic tool 112 in this way may interfere with the acoustic signals 122 that are received through the formation from accurately and/or reliable relaying the relevant information about the formation 101.

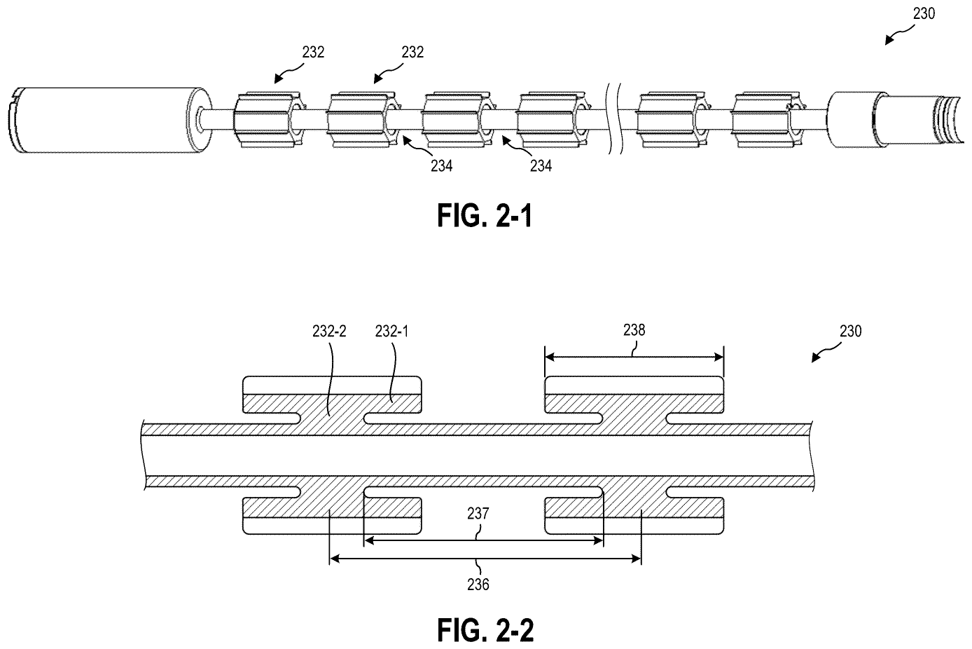

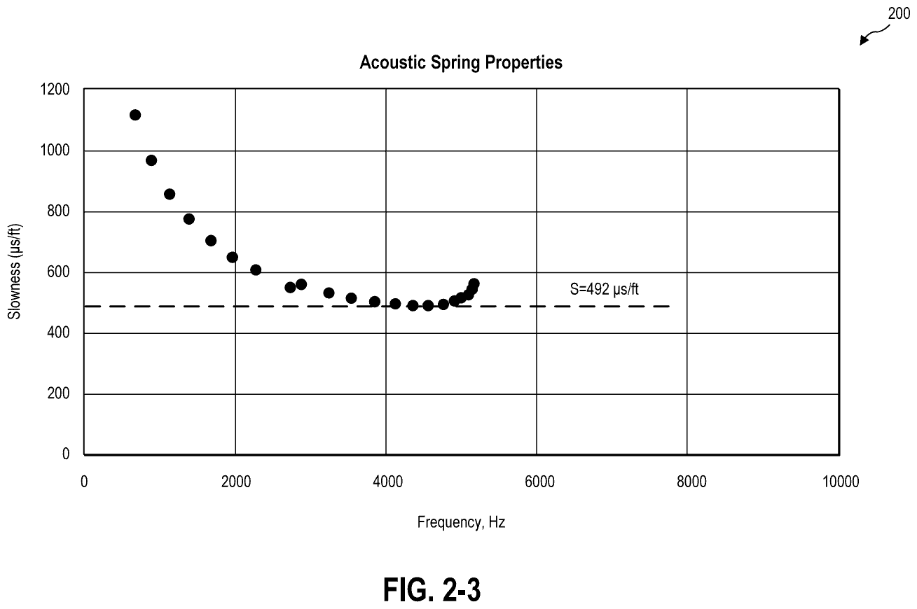

FIGS. 2-1 and 2-2 illustrate examples of a tool body 230 for an acoustic tool, according to embodiments of the present disclosure. The tool body 230 may be a tool body for a receiver portion of an acoustic tool (e.g., connected to a transmitter portion) or may be a tool body for a receiver portion and transmitter portion.

The tool body 230 may be constructed and/or configured as an acoustic body. For instance, the acoustic body may be an acoustic spring such as a mass-spring acoustic system tuned to achieve a specific acoustic performance of the acoustic body. To elaborate, the tool body 230 may have acoustic properties that are tuned to attenuate acoustic signals that may tend to travel through the tool body 230. For example, the tool body may have features, components, materials and/or geometric properties such that the tool body 230 prevents the propagation of acoustic signals through the tool body 230. For instance, the tool body 230 may have elastic, resonance, damping, flexural, and/or other physical properties such that sound waves of the frequency and amplitude of those of the acoustic signals transmitted by an acoustic tool do not readily travel through the tool body 230 and/or are not received by one or more acoustic receivers through the tool body 230.

The acoustic body of the tool body 230 may be formed of one or more mass bodies 232 connected via one or more spring bodies 234. The mass bodies 232 may be structures and/or elements that exhibit an increased moment of inertia over that of the spring bodies 234. For example, the mass bodies may include more material and/or heavier material such that the mass of the mass bodies 232 provide several instances or points along the tool body 230 having an increased moment of inertia. Additionally, the mass bodies 232 may extend radially further from an axis of the tool body 230 than the spring bodies 234, exhibiting a concentration of mass that is positioned further from the axis, further contributing to an increased moment of inertia of the mass bodies 232. The spring bodies 234 may be sections of the tool body 230 that are more uniform and a narrower gauge or diameter than the mass bodies 232. The spring bodies 234 may be somewhat elastic and may bend and/or deform in response to mechanical stress. In this way, the spring bodies 234 may facilitate an amount of flexing or bending along the tool body 230.

The tool body 230 in this way may be a mass-spring system that may behave in response to acoustic energy to store and release energy in a controlled manner, for example. This mass-spring distribution of the tool body 230 may facilitate isolating sensitive acoustic receivers (e.g., mounted on the tool body 230 as described herein) from unwanted vibrations, such as from acoustic signals travelling through the tool body 230. For example, the mass bodies 232 may act as vibration absorbers, wherein each mass-spring unit may dampen or filter out specific frequencies of vibration. In this way, the transmission of unwanted acoustic energy through the tool body 230 can be reduced or eliminated, thereby reducing noise and increasing measurement accuracy.

The mass-spring distribution of the tool body 230 may be defined by a unit length 236. For example, the unit length 236 may be the length from a point on a mass body 232 (e.g., such as a midpoint) to the same point on a next or adjacent mass body 232. In some embodiments, the unit length 236 may be 4 inches (e.g., 10.16 cm), or may be any other suitable length. The unit length 236 may be based on a positioning of a series of acoustic receivers on the tool body 230 at every 4 inches, so as to receive acoustic signals at discrete points along the acoustic tool.

The mass-spring distribution of the tool body 230 may be further defined by a spring length 237. The spring length 237 may be a length of the spring bodies 234. For example, in some cases the spring length 237 may be a length between adjacent spring bodies 234 or may be a length between mounting or base sections 232-2 of adjacent spring bodies 232 (e.g., in cases where the spring bodies 232 have an overhanging mass section 232-1). In some embodiments, the spring length 237 is 2 inches, 2.5 inches, 3 inches, 3.5 inches, 4 inches, 4.5 inches, 5 inches, any value therebetween, or any other suitable length. For example, in some cases, the spring length 237 is between 3 inches and 3.5 inches, such as 3.173 inches (e.g., between 7 centimeters (cm) and 9 cm, such as 8.059 cm), which may facilitate tuning the tool body 230 to attenuate propagation of acoustic signals through the tool body 230.

The mass-spring distribution of the tool body 230 may be further defined by a mass length 238. The mass length 238 may be a length of a weight or mass section 232-1 of the mass bodies 232. For example, the mass section 232-1 may be at an outer extent or radius of the mass bodies 232, and the mass section 232-1 may be connected to the spring bodies 234 by a mounting or base section 232-2. In some embodiments, the mass section 232-1 and the base section 232-2 are the same length, or the mass length 238. In some embodiments, the mass section 232-1 may overhang and/or may extend longitudinally further than the base section 232-2 such that the length of the mass section 232-1 is the mass length 238, and the base section 232-2 is somewhat shorter. The mass length and/or the overhanging mass section 232-2 may facilitate implementing a desired amount of mass and concentrating that mass away from the axis of the tool body 230, to tune the inertial properties of the acoustic body. In some cases, a mass body 232 may comprise several mass sections 232-1 connected around the base section 232-2, or in some cases the mass section 232-1 may be a continuous mass section body or structure positioned around the base section 232-2. In some embodiments the mass length 238 is 1.5 inches, 2 inches, 2.5 inches, 3 inches, 3.5 inches, 4 inches, any value therebetween, or other suitable length. For example, in some cases the mass length 237 is between 2 inches and 2.5 inches, such as 2.326 inches (e.g., between 5 cm and 7 cm, such as 5.908 cm), which may facilitate tuning the tool body 230 to attenuate propagation of acoustic signals through the tool body 230.

The specific configuration and/or dimensions of the mass-spring system may be defined in order to achieve a given acoustic property of the tool body 230. For example, the stiffness, k, of the spring bodies 234, and the mass, m, of the mass bodies 232 may be manipulated to achieve a specific k/m ratio, and ultimately to achieve a given flexural slowness or shear slowness of the tool body 230. For instance, the flexural slowness of the tool body 230 may be representative of a slowness dispersion of acoustic flexural waves propagating along the tool body 230. In some embodiments, the tool body 230 has a flexural slowness of greater than about 400 μs/ft, about 450 μs/ft, about 500 μs/ft, or any other value. In some cases, the tool body 230 has a flexural slowness of greater than about 490 μs/ft in order to attenuate acoustic signals of the frequency and/or amplitude of those transmitted by a downhole acoustic tool.

The tool body 230 may exhibit a desired flexural slowness for a range of frequencies (e.g., the frequency of a propagating acoustic signal for which the tool body 230 is attenuating). For example, the tool body 230 may achieve a given flexural slowness for acoustic signal frequencies up to about 3000 Hz, 3500 Hz, 4000 Hz, 4500 Hz, 5000 Hz, 5500 Hz, or any other value. In this way, the tool body 230 may be specifically configured to substantially reduce and/or prevent the transmission of acoustic signals through the tool body of the frequency and amplitude that are used in downhole acoustic measurements.

In some embodiments, the tool body 230 may exhibit a desired flexural slowness for the propagation of acoustic signals having an energy bandgap (e.g., stopband) of a particular frequency. For example, the flexural slowness may be further defined by an energy bandgap of about 3.5 kHz, 4. kHz, 4.5 kHz, 5 kHz, 5.5 kHz, 6 kHz, 6.5 kHz, or any value therebetween. In one particular example, the energy bandgap for acoustic signals propagating via the tool body 230 may be 5.5 kHz or greater to achieve a desired flexural slowness and/or other acoustic properties of the tool body 230, such as those described herein in connection with cement evaluation through tubing (CETT) operations.

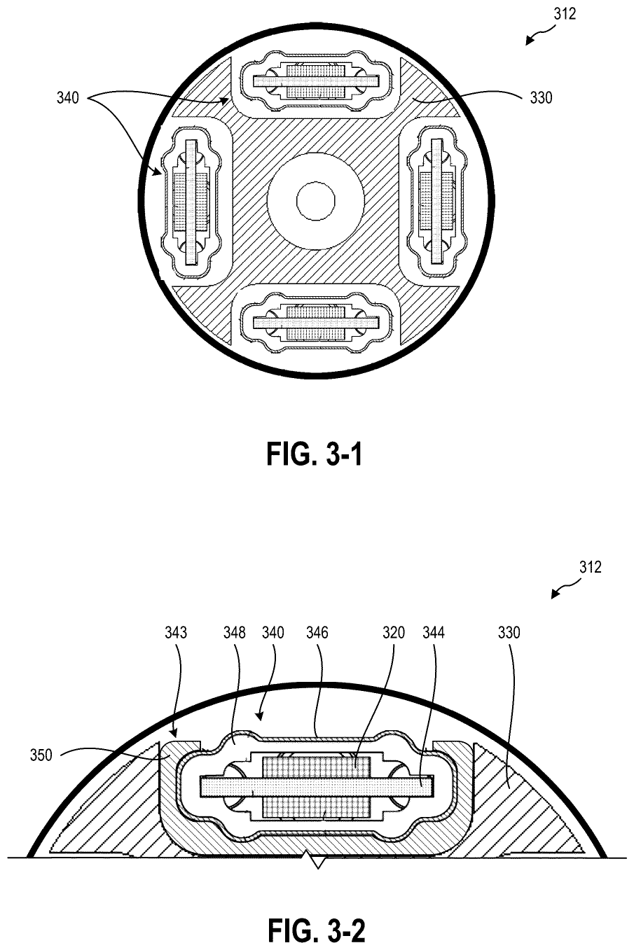

FIG. 2-3 illustrates example acoustic properties 200 of the tool body 230, according to at least one embodiment of the present disclosure. The acoustic properties illustrate flexural slowness of the tool body 230 implementing as an acoustic body as described herein, with respect to frequency of a propagating acoustic signal.

As described in further detail herein, in some cases, acoustic sensors may be mounted to the tool body at the mass bodies 232. Accordingly, the mass bodies 232 may be configured with a shape and/or form so as to facilitate securing acoustic sensors (and other associated componentry) thereto. For example, the mass bodies 232 may be equipped with ribs forming a slot or groove therein, and acoustic sensors may be mounted in one or more of the grooves on one or more of the mass bodies 232. In some embodiments, an array of eight acoustic sensors may be mounted on a given mass body 232 in eight grooves circumferentially disposed around the mass body 232.

FIG. 3-1 is a cross-section view, and FIG. 3-2 is a partial cross-section view of an acoustic tool 312, according to at least one embodiment of the present disclosure. The acoustic tool 312 includes a tool body 330. The tool body 330 may be a mandrel, tubular, or other body and/or may include any of the features described herein. The acoustic tool 312 may be of a size and form so as to be implemented in small-diameter tubulars, such as tubulars having a diameter of 6 inches or less, or tubulars having a diameter of 3 inches or less. For instance, the acoustic tool 312 may be implemented in a small-diameter bore of a downhole tool of a downhole tool string, or within a small-diameter wellbore.

The acoustic tool 312 may include one or more acoustic sensors 340. The acoustic sensors 340 may be positioned within the tool body 330, such as within a pocket 343 or recess of the tool body 330. The acoustic sensors 340 may be implemented as an acoustic receiver 320 disposed on or within a printed wiring assembly (PWA) 344 positioned within an enclosure 346. The enclosure 346 may be at least partially filled with an acoustic fluid 348 for facilitating the transmission of acoustic signals to the acoustic receiver 320, protecting the acoustic receiver 320 from downhole pressures, etc. The acoustic sensor 340 (e.g., via the enclosure 346) may be mounted and/or connected to the tool body 330 by one or more mounts 350 positioned in the pocket 343.

In this way, several sensors 340 may be implemented on the acoustic tool 312. For example, for a given longitudinal location of the acoustic tool 312 (e.g., as shown in the cross-section of FIG. 3-1) up to 4 acoustic sensors may be implemented. For instance, each acoustic sensor 340 may be implemented within a separate fluid-filled enclosure 346. The various acoustic sensors 340 may be positioned circumferentially around the tool body 330, for example, for receiving acoustic signals from different directions and/or locations.

In some embodiments, the acoustic tool 312 may be implemented with several sets or arrays of acoustic sensors 340 disposed along a longitudinal dimension of the acoustic tool. For example, the 4 acoustic sensors 340 (or other quantity) shown in FIG. 3-1 may be considered an array of acoustic sensors 340 disposed circumferentially around the tool body 330, and the acoustic tool 312 may include several (e.g., up to twelve or more) arrays of acoustic sensors 340 positioned longitudinally along the acoustic tool 312. In this way, the acoustic tool 312 may receive acoustic signals at several different longitudinal positions of the tool body 330.

In some embodiments, two or more acoustic sensors 340 at different longitudinal positions (e.g., from two or more different arrays) but at a same angular or circumferential position around to tool body 330 may be packaged within a same enclosure 346. For instance, the two or more acoustic sensors 340 in this example may be contained in the same body of acoustic fluid 348. For example, the enclosure 346 may be elongate in shape, and may house 2 or 3 or more acoustic receivers 320 included on a same or different PWAs 344. In this way, several arrays of acoustic sensors 340 may be implemented at several different longitudinal positions of the tool body 330 by way of several elongate enclosures 346 positioned around the circumference of the tool body 330.

In some cases, packaging the acoustic sensors 340 via several different enclosures 346 as shown in FIG. 3-1 may limit the number of acoustic sensors 340 that may be positioned around the periphery of the tool body 330. For example, because the acoustic sensors 340 for a given cross-section are positioned within separate enclosures 346, space may be limited for implementing more acoustic sensors than, for example, 4 at a given cross-section. This limitation may especially be the case in small-diameter tubular implementations (e.g., of 6 inches or less, or 3 inches or less) where packaging more than 4 acoustic sensors 340 in this manner may prove especially difficult.

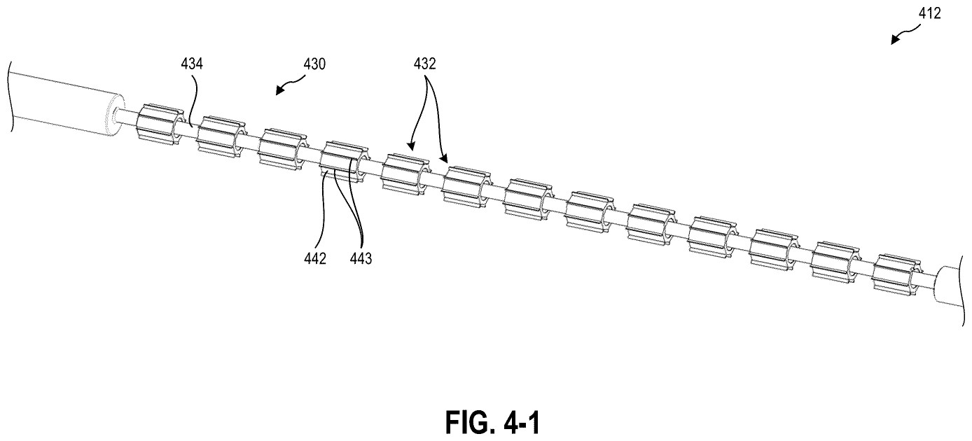

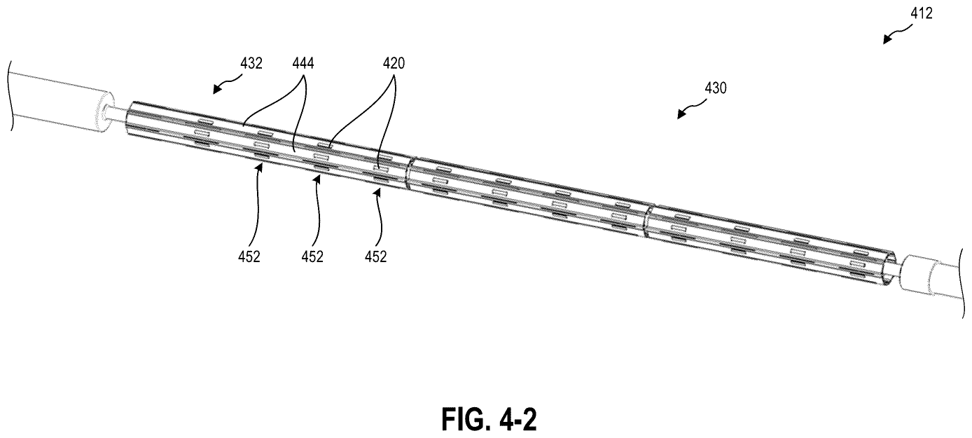

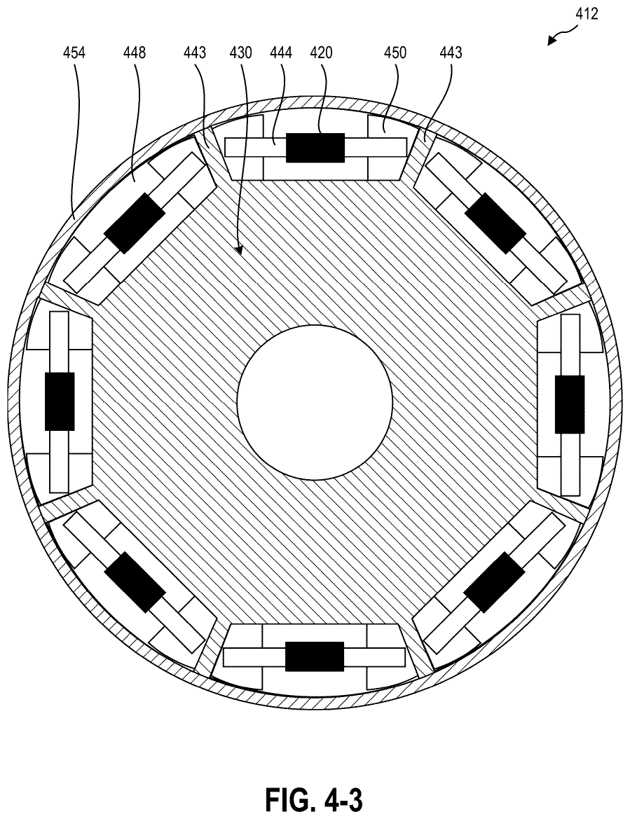

FIG. 4-1 illustrates a perspective view of an acoustic tool 412, and FIG. 4-2 illustrates a perspective view of the acoustic tool 412 having acoustic sensing components positioned thereon, according to at least one embodiment of the present disclosure. The acoustic tool 412 includes a tool body 430 and may include any of the features and functionalities of the tool body 230 described in connection with FIGS. 2-1 and 2-2. For instance, the tool body 430 may comprise an acoustic body formed from a plurality of mass bodies 432 and spring bodies 434.

The acoustic tool 412 may include a plurality of acoustic receivers 420 positioned around a periphery and/or outer surface of the tool body 430. For instance, the acoustic receivers 420 may be disposed on one or more PWAs 444. The acoustic receivers 420 may be connected to the tool body 430 at one or more of the mass bodies 432. For example, the PWAs 444 may be disposed in grooves 442 formed between ribs 443 on the mass bodies 432.

The acoustic tool 412 may include at least one acoustic receiver 420 or may include a plurality of acoustic receivers 420. For instance, the acoustic tool 412 may include one or more arrays 452 of one or more acoustic receivers 420 disposed around a periphery of a cross-section of the tool body 430. For example, the array 452 may be circumferentially disposed around a perimeter of the tool body 430. In some embodiments, the array 452 includes one, two, four, six, eight, or more acoustic receivers 420. The acoustic tool 412 may include a plurality of arrays 452 of one or more acoustic receivers 420. For example, as shown in FIG. 4-2, in accordance with at least one embodiment of the present disclosure, the acoustic tool includes twelve arrays 452 disposed longitudinally along the tool body 430, each having eight acoustic receivers circumferentially disposed around the tool body 430.

In some embodiments, two or more acoustic receivers 420 may be disposed on a same PWA 444. For example, a PWA 444 may include two, three, or more acoustic receivers disposed at longitudinal positions along the PWA 444. In this way, acoustic receivers 420 from different arrays 452 (e.g., on different mass bodies 432) may be contained on a single, same PWA 444. In this way, each array 452 may be implemented via a quantity of PWAs 444 corresponding to a quantity of acoustic receivers 420 in the array 452, and the PWAs 444 may span two or more arrays 452. In some embodiments, each PWA 444 may include 3 acoustic receivers 420 and may span 3 arrays 452. Thus, in some embodiments, the acoustic tool includes twelve arrays 452 disposed across 4 sets of PWAs 444. For example, a set of PWAs 444 may include 8 PWAs circumferentially disposed around the tool body 430, and the twelve arrays 452 of eight acoustic receivers 420 each may be disposed on 4 sets of eight circumferentially disposed PWAS 444 and connected at twelve mass bodies 432. The acoustic tool 412 includes a housing or enclosure (e.g., shown in FIG. 4-2) surrounding or encasing the tool body, acoustic receivers 420, etc.

FIG. 4-3 illustrates a cross-section view of the acoustic tool 412, according to at least one embodiment of the present disclosure.

As mentioned above, the acoustic receivers 420 (via PWAs 444) may be disposed within grooves 442 formed by ribs 443 of the tool body 430. The ribs may extend radially from the tool body 430. For example, the ribs 443 may be positioned on the mass bodies 432 of the tool body 430. The tool body 430 may include any number of ribs 443 forming any number of grooves 442 around one or more (or all) of the mass bodies 432. In some embodiments, the mass bodies 432 include eight ribs 443 forming eight grooves 442 circumferentially around the mass bodies 432.

The acoustic receivers 420 (via PWAs 444) may be positioned in the grooves 442 by mounts 450. The mounts 450 may be slotted such that the PWAs 444 may be slid in and may fit snugly in the mounts 450. The mounts 450 may be connected to the mass bodies 432 via adhesive, fasteners, mating geometric features (e.g., dovetail) or any other suitable means.

In some embodiments, the mounts 450 may be substantially the same length as the mass bodies 432 such that each mass body 432 supporting one or more PWAs 444 may have a corresponding set of one or more mounts 450. In some embodiments, the mounts 450 may be substantially the same length as the PWAs 444 such that, in embodiments where the PWAs 444 span multiple mass bodies 432, the mounts 450 may similarly engage with and be connected to multiple mass bodies 432. In this way, the PWAs 444 may be securely positioned on the tool body 430.

The mounts 450 may be made of rubber, polymer, or any other suitable material. For example, the mounts 450 may be made of a material that may serve to damped, reduce, and/or eliminate shocks and/or vibrations to the PWAs 444 and/or acoustic receivers 420. In this way, the acoustic receivers 420 may be protected against impacts to the acoustic tool 412. Additionally, the mounts 450 may contribute to vibrationally isolating the acoustic receivers 420 from acoustic signals travelling through the tool body 430.

In some embodiments, the acoustic tool 412 includes an enclosure 454. The enclosure 454 may be positioned around the tool body 430 such that the tool body 430 and associated components may be surrounded, encased, or enclosed by the enclosure 454. The enclosure 454 may be a thin-walled enclosure such as a thin-walled cylindrical sleeve or thin-walled cannister. In some embodiments, the enclosure 454 is rigid such as having a strength and rigidity to withstand the downhole environment. For example, the componentry of the acoustic tool 412 may be positioned within the enclosure 454 in this way to protect the componentry from the downhole environment, external loading, etc. The enclosure 454 may have a wall thickness at one or more locations that is thin so as not to prevent or inhibit the propagation of acoustic signals through the enclosure 454. For instance, the wall thickness may be 0.2 mm, 0.3 mm, 0.4 mm, 0.5 mm, 0.6 mm, or any value therebetween. In one particular embodiment, the wall thickness of the enclosure 454 may be from 0.3 mm to 0.4 mm to provide structural strength of the enclosure 454 while permitting the propagation of acoustic signals therethrough. In some embodiments, the enclosure 454 is implemented as a single, continuous enclosure 454 spanning an entirety of the acoustic tool 412, for example, including spanning multiple arrays 452 longitudinally disposed along the tool body 430. In some embodiments, the enclosure 454 may be implemented as several sections such a modular and/or interlocking sleeve sections.

In some embodiments, the enclosure 454 is not fully or entirely rigid. For example, as described herein the enclosure 454 may include one or more flexible regions or members for facilitating a bending and/or compliance of the tool body 430. The enclosure 454 may include one or more protective members or sleeves as described herein that may be positioned around or surrounding the flexible members, for example, for protecting and providing rigidity and strength to the acoustic tool. In some embodiments, the enclosure is formed of several sections that may interlock. For example, the enclosure may include a plurality of interlocking sleeves as described herein. The interlocking sleeves may be implemented in connection with, or independent of, a flexible member.

In some embodiments, the acoustic tool 412 includes an acoustic fluid 448 positioned within the enclosure 454. For example, the enclosure 454 may contain the acoustic fluid 448 which may at least partially submerge or cover the inner components of the acoustic tool 412. For example, the acoustic fluid 448 may be positioned between an inner surface of the enclosure 454 and componentry such as the PWAs 444, the acoustic receivers 420, etc. The acoustic fluid 448 may be a fluid which may promote the propagation or traveling of acoustic energy to and/or from the acoustic receivers 420, such as a pressure compensating fluid. For example, the acoustic fluid 448 may contact the acoustic receivers 420 and may form an acoustic coupling between the acoustic receivers 420 and the enclosure 454 (e.g., and therefore an environment outside of the acoustic tool 412). The acoustic fluid 448 may be dielectric in order to not interfere with or damage the electrical components. The acoustic fluid 448 may be any suitable fluid such as silicon oils, mineral oils, fluorinated fluids, etc.

In some embodiments, the acoustic fluid 448 may facilitate the acoustic tool 412 withstanding pressure changes and/or imbalances associated with the downhole environment. For example, the acoustic tool 412 may be implemented in a downhole environment having elevated pressures, and the acoustic fluid 448 may help to support the enclosure 454 and prevent the enclosure 454 from collapsing or crushing. In some embodiments, the acoustic fluid 448 in this way may facilitate implementing the acoustic tool 412 without incorporating a dedicated pressure compensation or equalization circuit. For example, the acoustic fluid 448 distributed around the entire circumference of the tool body 430 may facilitate withstanding elevated environmental pressures such that no pressure compensation piston or other device may be needed.

In this way, the acoustic tool 412 may include a plurality of acoustic receivers 420 implemented via a plurality of PWAs 444 and disposed around a periphery of the tool body 230. The acoustic tool 412 may facilitate implementing an increased quantity of acoustic receivers 420, for example, over that of other examples and/or conventional tools. For instance, by connecting and/or mounting the acoustic receivers 420 to the same tool body 430 and enclosing all of the acoustic receivers 420 within the same enclosure, more acoustic receivers 420 may be packaged in the acoustic tool 412 than may otherwise be the case for small-diameter implementations. To elaborate, because each acoustic receiver 420 at a given cross section (e.g., or on a given mass body 432) is contained in the same enclosure 454 and submerged in the same acoustic fluid 448, more acoustic receivers 420 may be positioned around the perimeter of the tool body 430 than is the case when implementing several different enclosures for housing the various acoustic receivers 420. In this way, the acoustic tool 412 may be implemented to capture higher-resolution data, for example, from eight acoustic receivers 420 at a given longitudinal location than from only 4.

As described above, the tool body 430 may be somewhat flexible and/or compliant, in order to attenuate the propagation of acoustic energy. Accordingly, the tool body 430 may tend to bend when subject to compressional forces and/or lateral loads. When the enclosure 454 is implemented as a rigid, thin-walled cannister, however, the enclosure 454 may tend not to flex under bending loads. Accordingly, in some situations where the tool body 230 may tend to bend, such as during rig up operations, when encountering deviations in a wellbore, etc., the enclosure 454 may fail under bending loads. For instance, the enclosure 454 may collapse, crease, oil-can, taco, or otherwise deform and fail. Such failure of the enclosure 454 can result in damage to the tool body 430, damage to the acoustic receivers 420, leaking or loss of the acoustic fluid, and/or disruption or ineffectiveness of an acoustic measurement operation, among other consequences.

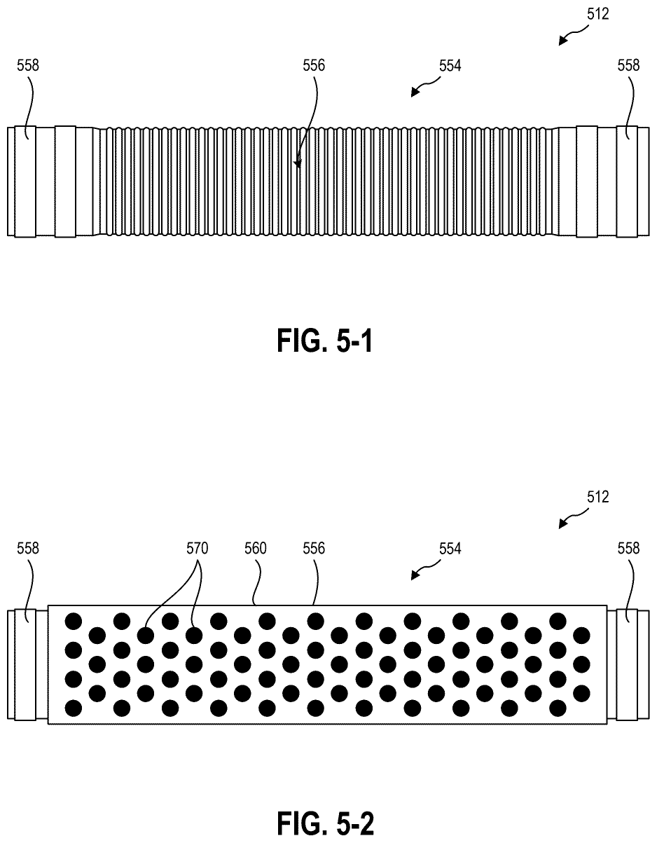

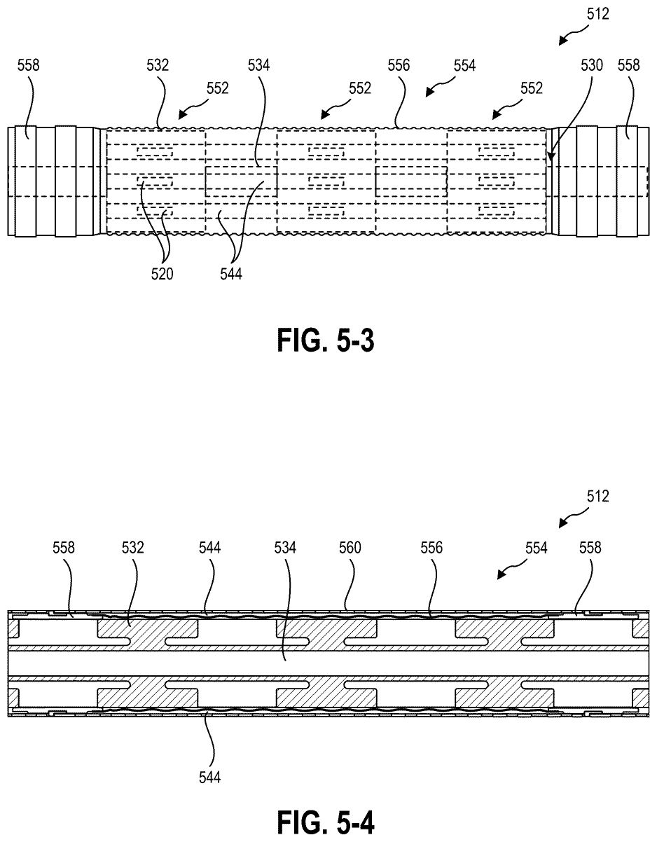

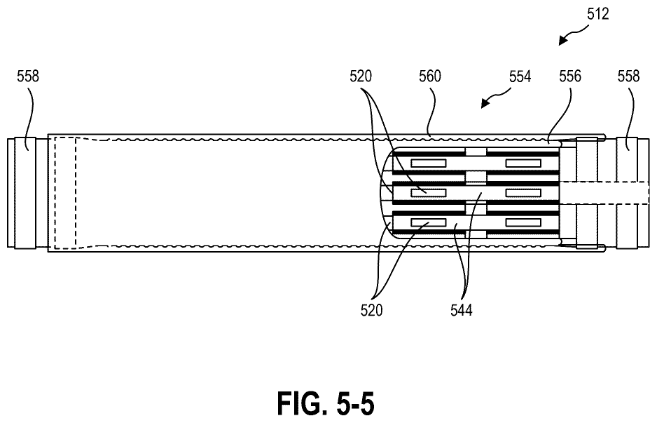

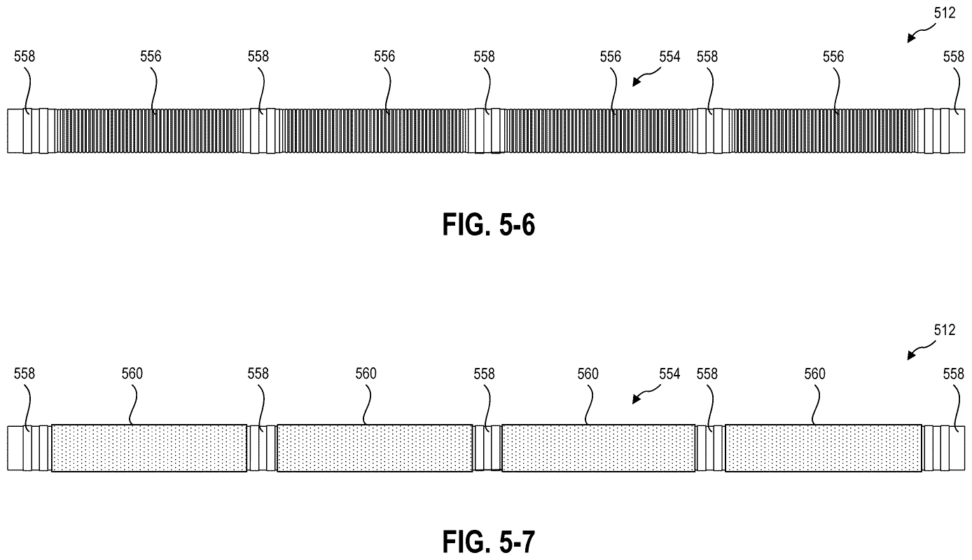

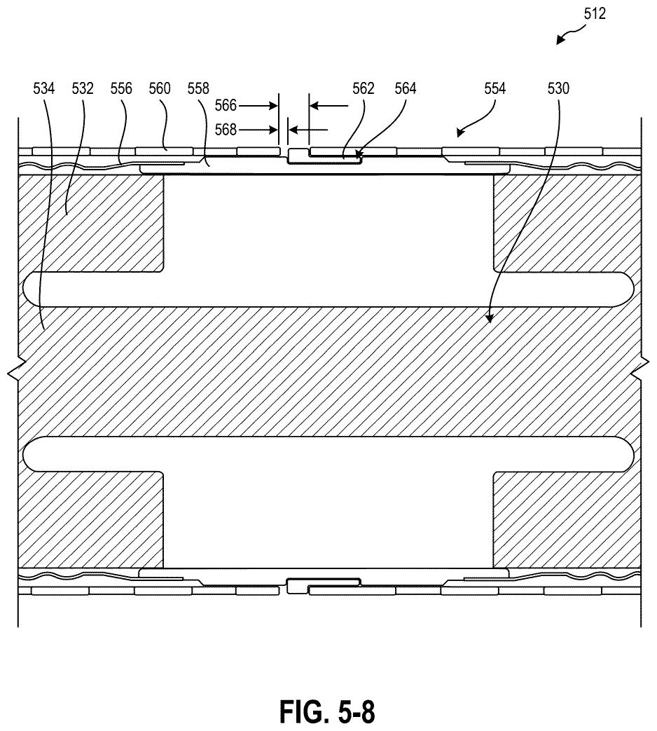

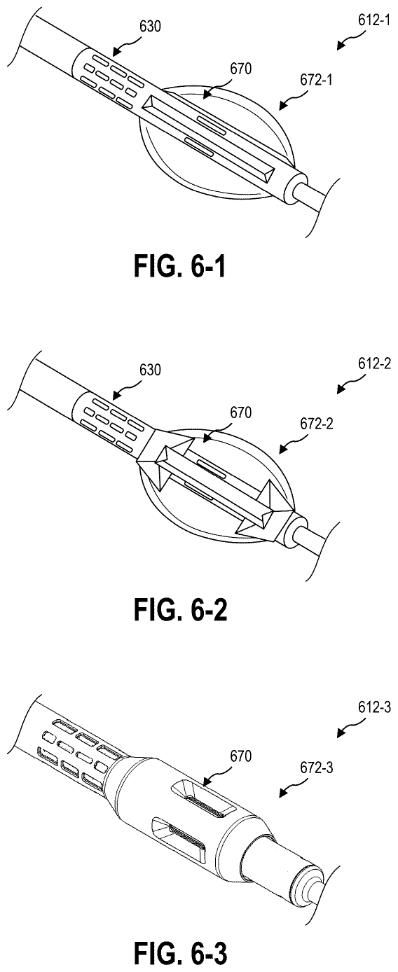

FIGS. 5-1 and 5-2 illustrates side views of a section or unit of an acoustic tool 512, according to embodiments of the present disclosure. FIG. 5-1 illustrates the unit of the acoustic tool 512 implemented with a flexible member, and FIG. 5-2 illustrates the unit of the acoustic tool 512 implemented with a flexible member and a protective member positioned thereover, according to embodiments of the present disclosure. FIG. 5-3 illustrates a side schematic view, FIG. 5-4 illustrates a side cross-section view, and FIG. 5-5 illustrates a side cutaway view of the portion of the acoustic tool 512, according to embodiments of the present disclosure. FIG. 5-6 illustrates the acoustic tool 512 having an enclosure comprised of several units each including a flexible member, and FIG. 5-7 illustrates the acoustic tool 512 having the enclosure comprised of the several units each including a flexible members with a protective member positioned thereover, according to embodiments of the present disclosure. FIGS. 5-1 through 5-7 will be discussed together.

The acoustic tool 512 may be substantially similar to and/or may include any of the features of any of the acoustic tools as described herein. For example, the acoustic tool 512 may include a tool body 530 implemented as an acoustic body with mass bodies 532 and spring bodies 534. Various acoustic receivers 520 may be mounted via PWAs 544 to the tool body 530 for receiving acoustic measurement signals.

The acoustic tool 512 may include an enclosure 554 which may include a flexible member 556. The flexible member 556 may be positioned around and may surround or enclose the tool body 530 and other inner components. For example, the flexible member 556 may contain an acoustic fluid within the acoustic tool 512 as described herein.

The flexible member 556 may be connected to, and disposed between, two couplers 558 of the enclosure 554. The couplers 558 may each be connected to and/or supported by one or more mass bodies 532, such as each spanning a space between two adjacent mass bodies 532 as described herein. The flexible member 556 may be sealed to the couplers 558 to form a fluid seal, for example, to contain the acoustic fluid within the enclosure 554. In some cases, the flexible member 556 may be electron beam welded to the couplers 558. The flexible member 556 may be connected to the couplers 558 through any other suitable means for securing the flexible member 556 and for creating a fluid seal.

The flexible member 556 may be flexible, elastic, compliant, or may otherwise deform. For example, the flexible member 556 may be made of an elastic material for facilitating flexure of the flexible member 556. In some cases, the flexible member 556 may be flexible based on a geometry or shape of the flexible member 556. For example, the flexible member 556 may include one or more folds, pleats, corrugations, or other shape in order to accommodate bending deformation of the flexible member 556. In accordance with one embodiment, the flexible member 556 has a bellows or concertina shape such that the flexible member 556 can flex and bend while retaining the fluid seal. In this way, the flexible member 556 may accommodate bending of the acoustic tool 512, for example, due to the flexible or compliant nature of the tool body 530.

The flexible member 556 may be made out of metal, such as stainless or other steel, or may be made out of aluminum or another metal or alloy. The flexible member 556 may be made of a material and/or may have a thickness such that the flexible member 556 does not substantially interfere with the transmission of acoustic signals through the flexible member 556.

The flexible member 556 may span a single array 552 of acoustic receivers 520 positioned on a single mass body 532 or may span multiple arrays 552 and mass bodies 532. For example, in some cases, the flexible member 556 may be disposed between the couplers 558 such that 3 arrays 552 and mass bodies 532 are contained within the flexible member 556. In some cases, such as is shown in FIG. 5-6, the enclosure 554 may include multiple flexible members 556 positioned and connected consecutively for forming multiple sections or units of the enclosure 554. The multiple flexible members 556 may all be fluidly connected such that the enclosure 554 encloses one continuous volume over the span of multiple flexible members 556. For example, multiple units may be fluidly connected such that the acoustic fluid may flow and/or be present continuously throughout the enclosure 554. In some embodiments, each unit may be isolated and/or may independently contain an enclosed volume.

In some embodiments, the flexible member 556 may facilitate the acoustic tool 512 withstanding pressure changes and/or imbalances associated with the downhole environment. For example, the acoustic tool 512 may be implemented in a downhole environment having elevated pressures which may apply inward pressure and/or forces on the enclosure 554. In other cases, elevated temperatures of the downhole environment may cause the acoustic fluid to heat up and expand, which may exert outward pressures and/or forces on the flexible member 556. The flexible member 556 being flexible may help to prevent the flexible member 556 from failing and/or being damaged due to these or other pressures. For example, the flexible member 556 may flex and/or deform in response to inward or outward pressure, for example, rather than collapsing or bursting. In some cases, the flexible member 556 may facilitate implementing the acoustic tool 512 in the downhole environment without incorporating a dedicated pressure compensation or equalization circuit for the enclosure 554.

In some embodiments, the enclosure 554 includes a protective member 560, as shown in FIG. 5-2. For example, the protective member may be positioned around or outside of the flexible member 556 and may protect the flexible member 556 from being damaged. The protective member 556 may be a sleeve, housing, cannister, or the like. The protective member 560 may be connected to and supported by one or more couplers 558. For example, the protective member 560 may be connected to and disposed between two couplers 558, which may be the same two couplers 558 to which the flexible member 556 is connected. The protective member 560 may be positioned around the flexible member without applying substantially any side or lateral loads to the flexible member 556. For example, the protective member 560 may prevent side or lateral forces exerted on the enclosure 554 from being transmitted to the flexible member (e.g., or other inner components). To elaborate, the protective member 560 may be supported by the tool body 530 via one or more mass bodies 532 and one or more couplers 558. In this way, any forces applied to the enclosure 554 that would otherwise have been applied to the flexible member 556 may instead by transferred and/or applied to the protective member 560 and may be transmitted to the tool body 530 via the couplers 558. In this way, the protective member 560 may protect the flexible member 556 from encountering lateral or side forces that may damage the flexible member 556. For example, the thin material thickness and/or flexible nature of the flexible member 556 may be such that the flexible member 556 may not be adequately equipped to withstand lateral forces of the extent that may typically be encountered in a downhole environment. In some cases, the protective member 560 may be positioned around the flexible member 556 without contacting the flexible member. In some cases, the protective member 560 may contact the flexible member 556 but may nevertheless substantially prevent forces from being applied to the flexible member 556.

The protective member 560 may be made of a material that has sufficient strength and rigidity to protect the flexible member 556 as described. For example, the protective member 556 may be made of stainless or other steel, or any other suitable material. In some embodiments the protective member 560 has a material thickness so as to not impede the transmission of acoustic energy through the enclosure 554. In some embodiments, the protective member 560 includes one or more acoustic windows 570 for facilitating the transmission of acoustic signals therethrough. For example, the protective member 560 may have one or more holes, perforations, openings, slots, windows, meshes, patterns, or other geometry or feature which may allow acoustic signals to travel through. In some embodiments, one or more acoustic windows 570 are implemented as portions of the protective member 560 of a different material and/or of a thinner material thickness such that acoustic energy may more freely pass therethrough. In some embodiments, the acoustic windows 570 may be positioned and configured in connection with a location of the acoustic receivers 520. In this way, the protective member 560 may provide protection to the acoustic tool 512 while not inhibiting the ability of the acoustic tool 512 to detect acoustic signals.

In a similar manner to the flexible member 556, the protective member 560 may span a single array 552 of acoustic receivers 520 positioned on a single mass body 532 or may span multiple arrays 552 and mass bodies 532. For example, in at least one embodiment, the protective member 560 may be disposed between the couplers 558 such that 3 arrays 552 and mass bodies 532 are contained within the protective member 560. In some cases, such as is shown in FIG. 5-7, the enclosure 554 may include multiple flexible member 556 positioned and connected consecutively for forming multiple sections or units of the enclosure 554. This may be in association with the enclosure 554 comprising multiple sections of flexible members 556, such as that shown and described in connection with FIG. 5-6.

In some case, the protective member 556 may be somewhat rigid, for example, in order to provide strength and protection to the inner components of the acoustic tool 512. As mentioned above, however, an enclosure that is substantially rigid and inflexible may present challenges associated with bending of the tool body 530. The enclosure 554 being formed of various sections of the protective member 560, and the protective members 560 being positioned and supported via the couplers 558, however, may facilitate the flexing and bending of the acoustic tool 512 despite the rigidity of the protective member 560. For example, in some cases, the couplers 558 may not be rigidly attached to the tool body 530 and/or mass bodies 532 such that the couplers 558 may have at least some play or freedom of movement (e.g., longitudinally) with respect to the tool body 530. Thus, the tool body 530 may flex and/or bend at least somewhat inside of the protective members 560. In another example, the bending of the tool body 530 may be facilitated by one protective members 560 angling or doglegging with respect to other protective members 560, despite each protective member 560 remaining rigid and/or unbent. For instance, a joint between adjacent protective members 560 may bend or flex, such as a bending or flexing of the coupler 558, while the protective members 560 may remain unbent. In this way, the enclosure 554 may exhibit both strong, rigid properties via the protective members 560 while also advantageously having at least some flexure by virtue of the protective members 560 being implemented as multiple interconnected sections or units.

FIG. 5-8 illustrates a cross-section view of a portion of the acoustic tool 512, according to at least one embodiment of the present disclosure. In some embodiments, the protective members 560 may be positioned and maintained in place by a retainer 562. The retainer 562 may be a retaining ring, split ring, clip, or any other suitable component. The retainer may be positioned in a retainer channel 564 formed in the coupler 558. The retainer 562 may prevent the protective member 560 from sliding or proceeding past the retainer 562 and in this way maintain a position of the protective member 560. For instance, the protective members 560 may be assembled or installed on the acoustic tool 512 by sliding the protective members 560 over the tool body 530, flexible members 556, etc. A retainer 562 may be installed at each coupler 558 between protective members 560.

Installing the protective members 560 in this way and maintaining the protective members 560 with the retainers 562 may facilitate the protective members 560 being modular and/or individually replaceable. For example, as described herein the protective members 560 may serve to protect the acoustic tool 512 from side loads, impacts, etc. Accordingly, in some cases one or more of the protective members 560 may become damaged. By implementing the enclosure comprised of several distinct protective members 560, the protective members 560 may each be removed, and those protective members 560 that become damaged may be individually replaced, while other protective members 560 may be reinstalled and reimplemented to service. In this way, the enclosure may be modular, and the entire enclosure 554 need not be replaces when a portion becomes damaged.

Between adjacent protective members 560 implemented in this way may exist an enclosure gap 566. The enclosure gap 566 may be measured from the end of one protective member 560 to the next protective member 560. The enclosure gap 566 may be 2 mm, 3 mm, 4 mm, 5 mm, 6 mm, 8 mm, 10 mm, or any other value or value therebetween. A retainer gap 568 may also exist between the retainer 562 and an adjacent or next protective member 560. The retainer gap 568 may be positioned in the enclosure gap 566. The retainer gap 568 and the enclosure gap 566 may facilitate and/or may be a product of manufacturing tolerances. In some cases, the retainer gap 568 and/or the enclosure gap 566 may facilitate thermal expansion and/or contraction of the components of the enclosure 554, for example, due to being exposed to the downhole environment. In some embodiments, the retainer gap 568 and/or the enclosure gap 566 may facilitate the bending and/or dogleg capabilities of the protective members 560 as described herein, such as allowing some movement, play, and or room for sliding between adjacent protective members 560.

FIG. 6-1 illustrates an example of an acoustic tool 612-1, FIG. 6-2 illustrates an example of an acoustic tool 612-2, and FIG. 6-3 illustrates an example of an acoustic tool 612-3, according to one or more embodiments of the present disclosure. The acoustic tools 612-1 through 612-3 may be substantially similar. For example, the acoustic tool 612-1 may include a transmission tool or portion and a receiver tool or portion that are axially connected to form the acoustic tool 612-1. FIGS. 6-1 and 6-2 may show a portion of the acoustic tool corresponding to a transmission portion. The acoustic tool 612-1 includes a tool body 630 and one or more acoustic transmitters 670. For example, the acoustic tool 612-1 may be a tool (or a portion of a tool) for transmitting acoustic signals through a formation, to be received by acoustic receivers as described herein. The one or more acoustic transmitters 670 may include monopole transmitters, dipole transmitters, quadrupole transmitters, and combinations thereof.

In some embodiments, the acoustic tool 612-1 includes one or more transmission amplifiers 672-1. For example, the transmission amplifiers 672-1 may include a mass or body that may extend outwardly from the tool body 630. In some cases, the transmission amplifiers 672-1 may be utilized in applications where the acoustic tool 612-1 is implemented in a larger tubular (e.g., larger than the tool body 630) such that the acoustic tool 612-1 may fit with the addition of the laterally extending transmission amplifiers.

The transmission amplifiers may comprise an acoustic fin structure for facilitating increasing or amplifying the acoustic signals transmitted from the acoustic tool 612-1. For instance, the transmission amplifiers 672-1 may facilitate adding mass and/or increasing the inertia of the acoustic tool 612-1 at or near the acoustic transmitters 670. This increase in mass and inertia may reduce the tendency of the acoustic transmitters 670 to excite the acoustic signal transmissions into the tool body 630 (e.g., to vibrate the tool body) and the acoustic transmitters 670 may accordingly more effectively transmit the acoustic signals outward from the tool body 630 and into the surrounding formation.

In some embodiments, the mass and/or positioning of the transmission amplifiers 672-1 may be configured so as to tune a natural frequency of the tool body 630 in accordance with the acoustic signals and thereby increase a resonance with which the acoustic tool 612-1 transmits the acoustic signals. In some embodiments the transmission amplifiers 672-1 may be implemented as several, separate acoustic fin structures, for example, positioned around the tool body. In other examples, such as that shown in FIG. 6-2, a transmission amplifier 672-2 may be implemented as several acoustic fin structures that may be joined and/or connected as a larger body. In other example, such as that shown in FIG. 6-3, a transmission amplifier 672-3 may be implemented as a connected and/or continuous housing having thicker portions as the transmission amplifier 672-3 and thinner portions and/or acoustic windows for enabling the transmission of acoustic signals therethrough.

The transmission amplifiers 672-1 and 672-2 (e.g., 672 collectively) may also facilitate directing and/or focusing the transmission of the acoustic signals from the acoustic transmitters 670. For example, the transmission amplifiers 672 may have the acoustic fin structures which may serve as partitions or barriers between adjacent acoustic transmitters. In some embodiments, there may be one acoustic fin structure positioned between each of the acoustic transmitters 670. For instance, there may be two, four, eight or more acoustic fin structures. For instance, the transmission amplifiers 672 may direct a first set of acoustic signals in a first direction (e.g., at a first angle or range) and may direct a second set of acoustic signals in a second direction independent of the first direction. In this way the transmission amplifiers 672 may prevent the first and second sets of acoustic signals from overlapping and/or interfering with each other. This may facilitate the transmission of the acoustic signals into specific regions or portions of the formation (e.g., at specific angles) without interfering with or causing noise to adjacent or neighboring signals. In this way, the transmission amplifiers may facilitate more reliable and accurate acoustic information.

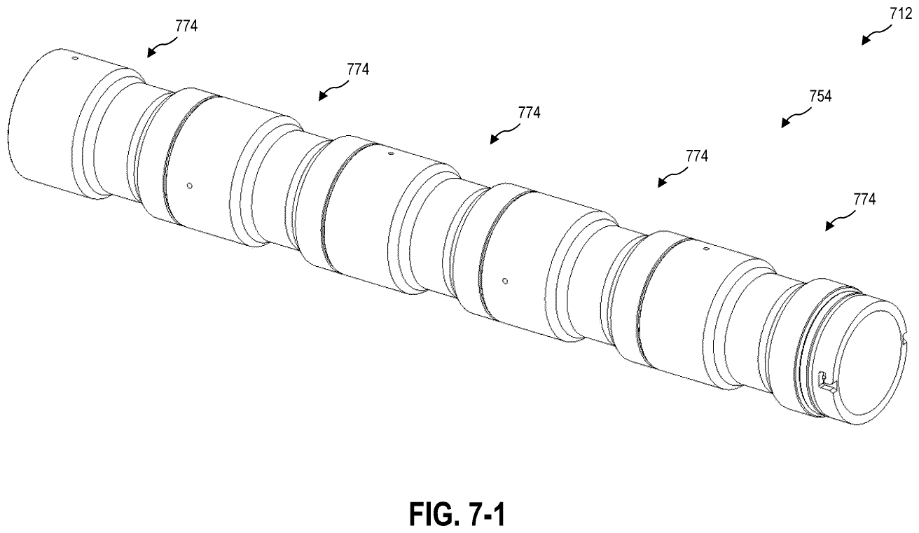

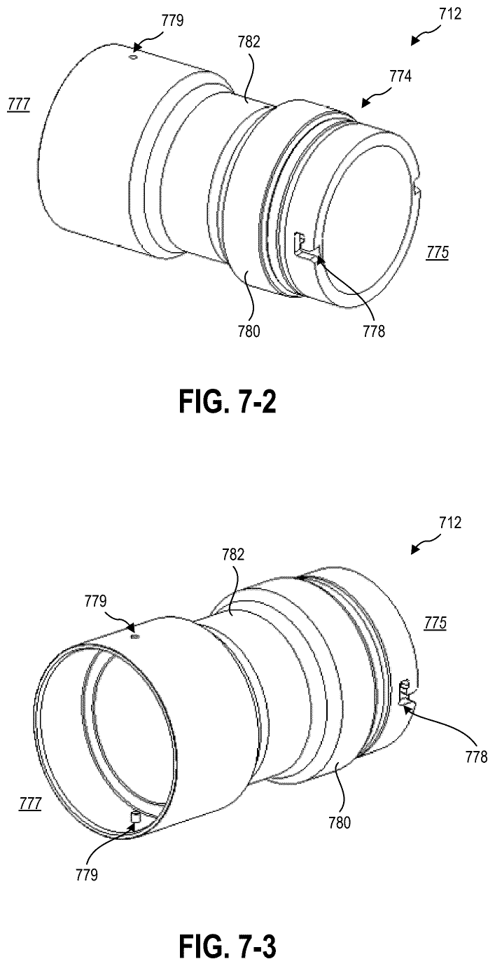

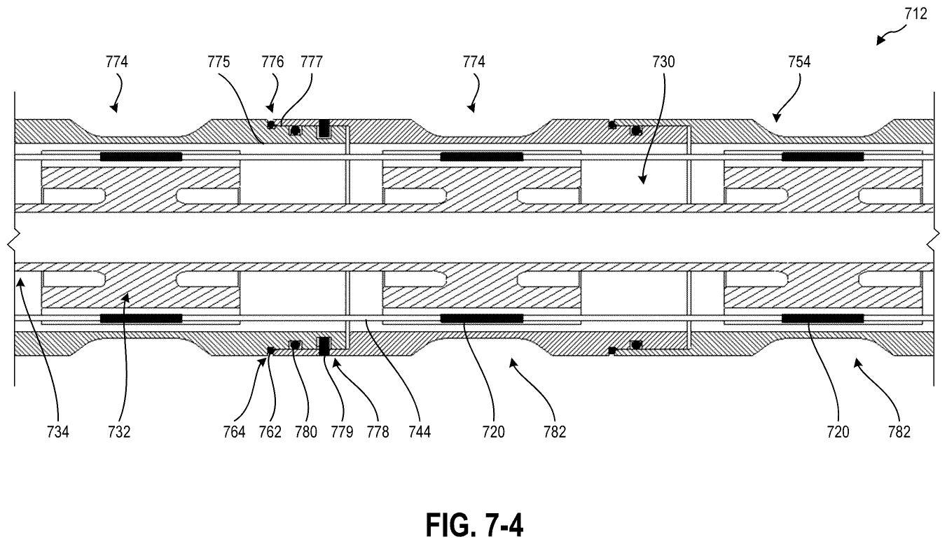

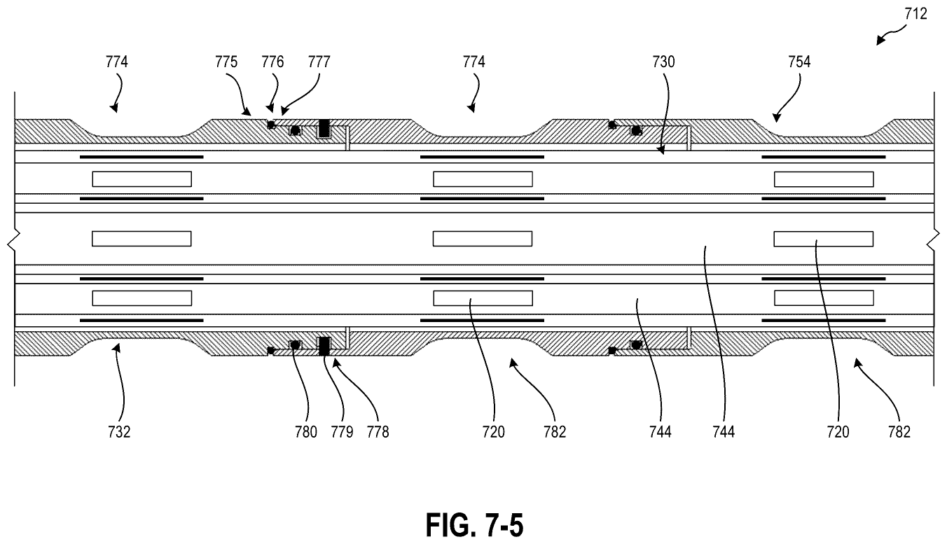

FIG. 7-1 illustrates a perspective view of an enclosure 754 for an acoustic tool 712, according to at least one embodiment of the present disclosure. FIG. 7-2 illustrates a first perspective view and FIG. 7-3 illustrates a second perspective view of an interlocking sleeve 774 of the enclosure 754, according to at least one embodiment of the present disclosure. FIG. 7-4 illustrates a side cross-sectional view of the acoustic tool 712 and FIG. 7-5 illustrates a side cutaway view of the acoustic tool 712, according to at least one embodiment of the present disclosure.

The acoustic tool 712 may include a tool body 730 that may be substantially similar to and/or may include any of the features of any of the tool bodies as described herein. For example, as shown in FIGS. 7-4 and 7-5, the tool body 730 may be implemented as an acoustic body with mass bodies 732 and spring bodies 734. Various acoustic receivers 720 may be mounted via PWAs 744 to the tool body 730 for receiving acoustic measurement signals.

With reference again to FIGS. 7-1 to 7-5 generally, as mentioned, the acoustic tool 712 includes an enclosure 754. The enclosure 754 may be positionable about or around the tool body 730, for example, to enclose the tool body 730, acoustic receivers 720, etc. within an inner volume of the enclosure 754, as described herein. The enclosure 754 may be implemented as several separate, distinct sections which may be connectable to form the enclosure 754. For example, the enclosure 754 may be formed from a plurality of interlocking sleeves 774. The interlocking sleeves 74 may have a somewhat cylindrical shape and/or a round cross-section, and may have a hollow inner volume or inner bore therethrough. In this way the interlocking sleeves 774 may slide or be positioned over or around the tool body 730 and connected in order to form the enclosure 754 around the tool body 730. In some embodiments, the interlocking sleeves 774 may all be the same, or one or more of the interlocking sleeve 774 may be different and/or may exhibit one or more different aspects, qualities, features, shapes, etc.

As shown in FIGS. 7-4 and 7-5, the interlocking sleeves 774 may connect by forming sleeve interfaces 776 between adjacent interlocking sleeves 774. For example, the interlocking sleeves 774 may have a first end 775 and a second end 777. The first end 775 (e.g., of one interlocking sleeve 774) and the second end 777 (e.g., of another interlocking sleeve 774) may mate with each other, such as by fitting inside of one another. For instance, the first end 775 may be a male portion or male end, and the second end 777 may be a female portion or female end (or vice versa), and the male end may fit at least somewhat inside the female portion. In some embodiments, the first end 775 and the second end 777 connect without fitting inside of each other, such as by a surface mating or abutting one another.

The first end 775 and the second end 777 may form a connection to connect adjacent interlocking sleeves 774. For example, as shown in FIGS. 7-2 and 7-3, the first end 775 may include a first connecter 778 and the second end 777 may include a second connecter 779. The first connector 778 and second connector 779 may mate and/or engage with each other in order to form a connection between the first end 775 and the second end 777 to fix or secure adjacent interlocking sleeves together. For example, the first connector 778 may be a slot (e.g., a J slot) and the second connector 770 may be a pin, detent, etc. which may mate with the slot (or the first connector 778 may be a pin and the second connector 770 a slot). The first connector 778 may be located on an outer surface of the (e.g., male) first end 775, and the second connector 779 may be located on an inner surface of the (e.g., female) second end 777. Based on the first end 775 and the second end 777 inserting inside of each other, the first connector 778 and the second connector 779 may engage and may maintain the first end 775 and the second end 777 connected. For example, the first end 775 may be inserted into the second end 777 and the interlocking sleeves 774 may be connected by aligning the first connector 778 and the second connector 779 and rotating the interlocking sleeves 774 with respect to one another in order to engage or lock the connection of the first connector 778 and the second connector 779. In this way, the sleeve interface 776 may be formed be connecting adjacent interlocking sleeves 774.

In some embodiments, the interlocking sleeve 774 may include two or more first connecters 778 at the first end 775, and accordingly, two or more second connectors 779 at the second end 777. The multiple instances of these connectors may be spaced, for example, 180° apart, or at any other interval (e.g., evenly spaced radially around the interlocking sleeve 774). In some embodiments, the first connector(s) 778 and the second connector(s) 779 on a same interlocking sleeve 774 may be radial aligned as a same radial position, or may be radially offset, such as 90° offset. The (e.g., 90°) radial offset may facilitate flexibility and/or bending of the enclosure 754, as described herein, in different directions.

The sleeve interface 776 may be a sealed interface such that an inner volume of the enclosure 754 is sealed (e.g., fluid sealed). For example, the sleeve interface 776 may include a seal 780 positioned between the first end 775 and the second end 777 of adjacent interlocking sleeves 774. The seal may be implemented as a sealing element such as an O-ring seal, a V-ring seal, or a gasket, may include a sealant such as an epoxy, adhesive or other sealing, and/or may be implemented as mating sealing surfaces such as polished surfaces. In this way, adjacent interlocking sleeves 774 may be sealed to one another, which may facilitate enclosing and/or containing an acoustic fluid within the enclosure as described herein. For example, an acoustic fluid may be contained within a sealed inner volume of the enclosure 754 and may surround the tool body 730, the acoustic receivers 720, etc. for providing an acoustic medium through which acoustic signals may propagate as well as providing electrical insulation to electrical components.

The sleeve interface 776 may include a retainer 762 for retaining and/or fixing the connection of the interlocking sleeves 774, and more specifically, for maintaining the engagement of the first connector 778 and the second connector 779. For example, when the interlocking sleeves 774 are connected together, and the first connector 778 and second connector 779 are engaged, a small gap or channel 764 may be present. The channel 764 may be due to geometric manufacturing tolerances, and in some cases, may facilitate connecting the first connector 778 to the second connector 779, such as in a pin and J-slot configuration. In some cases, the channel 764 may introduce a potential for the first connector 778 and the second connector 779 to become disengaged and for the interlocking sleeves to become separated or disconnected. The retainer 762 may be positioned in the channel 764 to prevent disengagement of the connectors and separation of the interlocking sleeves 774. For example, the retainer 762 may be implemented as a clip (e.g., circlip), ring (e.g., C-ring), pin, or other retainer which may be inserted or positioned after the interlocking sleeves 774 are connected in order to maintain the connection.

In this way, the enclosure 754 may be formed by connecting adjacent interlocking sleeves with the sleeve interface 776 as described. For example, several interlocking sleeves 774 may be connected end to end in this manner to form an enclosure 754 having a length that may span a length of the tool body 730. For example, as mentioned above, in some cases the tool body 730 may include twelve arrays of one or more sensors (e.g., eight sensors per array) arranged longitudinally along the tool body 730. The enclosure 754 may accordingly be formed from twelve interlocking sleeves 774.

The enclosure 754 may be positioned about, around, or encompassing the tool body 730 in order to protect the tool body. For example, the enclosure 754 may be substantially strong so as to protect the tool body 730 (e.g., and the acoustic receivers 720) from loads or forces that may act on the side of the acoustic tool 712 (e.g., transvers to the longitudinal dimension of the acoustic tool 712). For example, lateral or side loads on the enclosure 754 may cause one or more of the interlocking sleeves 774 to contact the tool body 730 at one or more mass bodies 732 (e.g., contact a fin of the mass bodies 732 as described herein), which may effectively transfer or apply the force to the tool body 730, for example, rather than to the acoustic receivers 720, PWA, 744, etc. In this way, the enclosure 754 may protect the delicate electronics of the acoustic tool 712.

In some embodiments, the tool body 730 may be positioned within the enclosure 754 loosely, for example, without being fixed to the enclosure 754 at one or more locations. For example, the tool body 730 may be connected at one or more ends to one or more downhole tools (e.g., and/or to the enclosure 754) and the tool body 730 may not be fixed or secured to the enclosure 754 along a midsection of the tool body 730. In this way, the tool body 730 may float within the enclosure 754, which may facilitate bending of the tool body 730 as described. In some embodiments, the tool body 730 may be connected or fixed to the enclosure 754 at one or more locations along the tool body 730.

While the enclosure 754 may provide strength and protection against loading of the acoustic tool 712, the enclosure 754 may also provide flexibility in order to accommodate flexibility and/or bending of the tool body 730. For example, as described herein, the tool body 730 may be a mass spring body and may experience flexure to a certain degree. The modular nature of the enclosure 754 being formed of several interlocking sleeves 774 may facilitate at least some bending of the enclosure 754 to accommodate bending of the tool body 730. For example, the sleeve interface 776 as described may be formed based on mating surfaces, geometries and/or features of the first end 775 and second end 777 of adjacent interlocking sleeves 774. These components may interface, interact, engage, and/or mate based on geometric dimensioning and tolerances. For example, the interlocking sleeves 774 may be manufactured according to certain tolerances or clearances such that the interconnecting features as described herein may fit with each other. These tolerances, however, may allow for a certain amount of play, movement, wiggle room, latitude, margin, room, space, freedom, etc., between the mating features of the sleeve interface 776 such that adjacent interlocking sleeves may rotate (e.g., in the bending or longitudinal direction) with respect to one another at least somewhat. In this way, the enclosure 754 may exhibit pseudo bending, as the enclosure 754 as a whole may exhibit bending based on movement between the interlocking sleeves 774 while the interlocking sleeves 774 themselves may not necessarily bend. For instance, the pseudo bending between a given pair of adjacent interlocking sleeves 774 may be slight or small, but this small pseudo bending may be compounded across several (e.g., up to twelve or more) interlocking sleeves 774 that are connected to form the enclosure 754. In some embodiments, one or more (or all) of the interlocking sleeves 774 may exhibit true bending (e.g., the material of the interlocking sleeve 774 may bend).

In some embodiments, the interlocking sleeve 774 includes an acoustic window 782. The acoustic window 782 may be a portion of the interlocking sleeve 774 having a shape, geometry, material, thickness, etc., which may enable acoustic signals to pass through the enclosure 754. For example, in some cases the acoustic window 782 may be formed as a portion of the interlocking sleeve having a specified thickness. For example, the acoustic window 782 may be a portion of the interlocking sleeve 774 having a reduced thickness. For instance, as shown in FIGS. 7-1 to 7-5, the acoustic window 782 may be formed as a depression, groove, cutout, or slope formed in the outer surface of the interlocking sleeve 774, but may also be formed at or on the inside surface (inner diameter) of the interlocking sleeve 774. The acoustic window 782 may span around an entirety of the circumference of the interlocking sleeve 774, or may be positioned at one or more discrete (e.g., non-continuous) locations around the interlocking sleeve 774.

In this way, the enclosure 754 may be formed from several interlocking sleeves 774, and may be implemented in connection with the tool body 730 in order to have a reduced or minimal effect on the propagation of acoustic signals to and/or from the acoustic receivers 720. For example, as shown in FIGS. 7-4 and 7-5, the interlocking sleeves 774 may be positioned such that the acoustic windows 782 align with the acoustic receivers 720. For instance, the acoustic windows 782 may be positioned adjacent or near the acoustic receivers 720 and in some cases may not contact the acoustic receivers 720 (e.g., the acoustic fluid may be positioned between the acoustic receivers 720 and the acoustic windows 782).

In some embodiments, the acoustic window 782 may be implemented as a portion of the interlocking sleeve 774 having a specific material thickness. The material thickness may be 0.5 millimeters (mm), 0.8 mm, 1 mm, 1.5 mm, 2 mm, 2.5 mm, 3 mm, 3.5 mm, 3.6 mm, 4 mm, or any value therebetween. In some cases, the acoustic window 782 is implemented as a material thickness particularly of between 0.8 mm and 3.6 mm in order to have sufficient thickness to provide strength so as to withstand loading on the enclosure, while being sufficiently thin to enable acoustic signal propagation therethrough without incurring detrimental signal interference in a frequency and slowness measurement regime of interest.

For example, in some cases an acoustic tool as described herein (e.g., the acoustic tool 712) may be implemented in a wellbore for evaluating a cement quality of a casing cement. For instance, a downhole tool string may be positioned within the wellbore for transmitting acoustic signals to and through the cement, which acoustic signals may be received by that acoustic tool to evaluate aspects of the cement based on frequency, slowness, etc. of the received acoustic signals. In some embodiments in particular, the wellbore may include a tubular such as a production tube within the wellbore, and the acoustic tool may be implemented from within the production tube. In such cases, it may be challenging to emit, propagate, and receive acoustic signals, for example, through the tubular, through the wellbore casing, and into the cement and back again. For instance, such cement evaluation through tubing (CETT) operations may specifically rely on a measurement regime or area of interest of the acoustic signals having a specific frequency range and slowness range. For example, for CETT operations, the measurement area of interest for the acoustic signals may be a frequency from about 3 kHz to about 16 kHz, and may be a slowness from about 0 μs/ft to about 200 μs/ft. In accordance with at least one embodiment, the measurement area of interest may particularly be from about 4 kHz to about 7 kHz in order to accurately evaluate cement quality from within a tubing positioned within a cased wellbore.

In some cases, acoustic tools (e.g., any of the acoustic tools 412, 670, 712, etc., described herein) and other associated componentry connected thereto may exhibit or produce one or more modes of interference, aliasing, or signal distortion, for example, based on resonance and/or signal propagation through the body or housing of the tools/components (e.g., rather than solely through the formation, cement, etc.). This signal aliasing may be problematic when it occurs in the frequency and slowness range(s) of the measurement regime of interest. Any of the acoustic tools as described herein may be particularly tuned in order to prevent and/or attenuate signal interference of the acoustic tool in this measurement area of interest. For instance, the mass-spring system of the tool body, the material thickness of any of the enclosures, etc., may be manipulated and/or particularly implemented having a specific geometry and configuration in order to prevent aliasing or interference in the measurement area of interest. With respect to the acoustic tool 712 specifically, in some cases, the acoustic tool 712 may implement the enclosure 754 as described herein having the plurality of interlocking sleeves 774, and in particular the acoustic window 782 of a thickness between 0.8 mm and 3.6 mm in order to prevent signal aliasing of the acoustic tool 712 in the measurement regime of interest (e.g., for CETT). In this way, the acoustic tool 712 may be tuned for detecting signals of a specific frequency and slowness range, for example, in order to perform CETT operations.

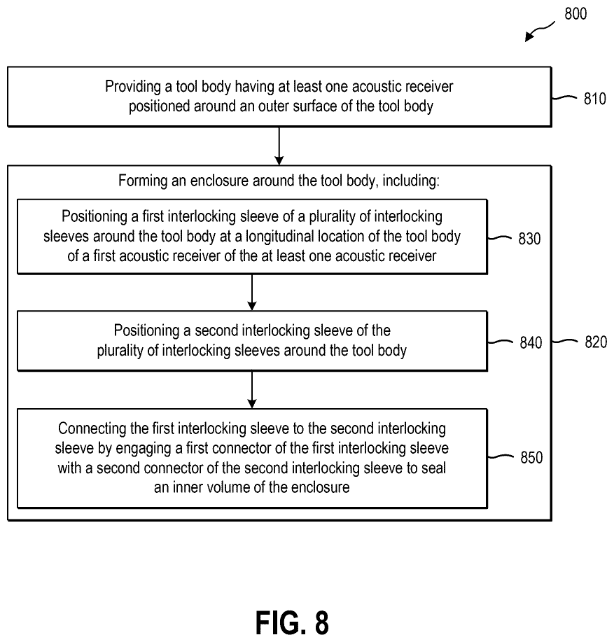

FIG. 8 illustrates a flow diagram for a method or a series of acts for assembling a downhole acoustic tool as described herein, according to at least one embodiment of the present disclosure. While FIG. 8 illustrates acts according to one embodiment, alternative embodiments may add to, omit, reorder, or modify any of the acts of FIG. 8.

In some embodiments, the method 800 includes an act 810 of providing a tool body having at least one acoustic receiver positioned around an outer surface of the tool body.

In some embodiments, the method includes an act 820 of forming an enclosure around the tool body.

In some embodiments, the act 820 includes a sub act 830 of positioning a first interlocking sleeve of a plurality of interlocking sleeves around the tool body at a longitudinal location of the tool body of a first acoustic receiver of the at least one acoustic receiver.

In some embodiments, the act 820 includes a sub act 840 of positioning a second interlocking sleeve of the plurality of interlocking sleeves around the tool body.

In some embodiments, the act 820 includes a sub act 850 of connecting the first interlocking sleeve to the second interlocking sleeve by engaging a first connector of the first interlocking sleeve with a second connector of the second interlocking sleeve to seal an inner volume of the enclosure.

In some embodiments the method 800 further includes filling the enclosure with an acoustic fluid such that at least some of the acoustic fluid is positioned between an inner surface of the enclosure and the at least one acoustic receiver.

In some embodiments, the method 800 further includes rotating the first interlocking sleeve with the second interlocking sleeve to engage the first connector with the second connector.

In some embodiments, the method 800 further includes positioning a seal between the first interlocking sleeve and the second interlocking sleeve to seal the inner volume of the enclosure.

In some embodiments, the plurality of interlocking sleeves each include an acoustic window, the method further comprising aligning the acoustic window of the first interlocking sleeve with the first acoustic receiver.

In some embodiments, the method 800 further includes bending the enclosure at a sleeve interface between the first interlocking sleeve and the second interlocking sleeve based on a tolerance of the sleeve interface to accommodate a bending of the tool body.

In some embodiments, the downhole acoustic tool includes twelve acoustic sensors positioned at twelve longitudinal locations along the tool body. The method 800 may further include forming the enclosure from twelve interlocking sleeves including positioning the twelve interlocking sleeves at the twelve longitudinal locations, and connecting the twelve interlocking sleeves based on engaging first and second connectors of adjacent interlocking sleeves of the twelve interlocking sleeves to seal the inner volume of the enclosure.

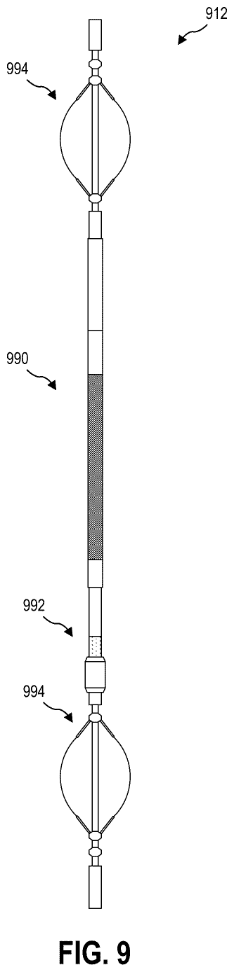

FIG. 9 is a side view of an acoustic tool 912, according to at least one embodiment of the present disclosure. The acoustic tool 912 may be made up of several tools or portions, for example, connected axially to form an elongate or tubular structure. The acoustic tool 912 may be configured for positioning within a wellbore to provide evaluation and/or surveying from within the wellbore as described herein. For instance, the acoustic tool 912 may include one or more stabilizer 994 which may contact the wellbore wall (or other tubular within which the acoustic tool 912 is positioned) and may position, center, and/or stabilize the acoustic tool 912 within the wellbore.

The acoustic tool 912 may include a receiver tool 990 and a transmission tool 992. The receiver tool 990 and the transmission tool 992 may be connected axially, for example, either directly or via on or more additional components. In some embodiments, the receiver tool 990 may be positioned uphole of the transmission tool 992 or vice versa. The transmission tool 992 may be similar to and/or may include any of the features of the transmission tools as described herein, such as in connection with FIGS. 6-1 through 6-3. The transmission tool 992 may emit or transmit one or more acoustic signals in one or more directions which may facilitate evaluating a surrounding formation, cement, etc., as described herein. The receiving tool 990 may include one or more acoustic receivers for receiving the acoustic signals as transmitted from the transmission tool 992 and having traveled through the formation, cement, etc., as described herein. The receiver tool 990 may be configured in accordance with any of the acoustic tools as described herein, for example, having a tool body, acoustic receivers, enclosure, etc., as described herein. In this way, the various components and/or tools as described herein may be connected and/or implemented together in order to facilitate taking downhole measurements.

### INDUSTRIAL APPLICABILITY

The following sections are non-limiting examples of embodiments of the present disclosure:

A1. A downhole acoustic tool, comprising:
a tool body comprising a plurality of mass bodies connected via one or more spring bodies for forming an acoustic body;
a plurality of acoustic receivers positioned around the tool body on at least some of the plurality of mass bodies;
an enclosure surrounding the tool body and the plurality of acoustic receivers; and
an acoustic fluid contained within the enclosure, at least some of the acoustic fluid being positioned between an inner surface of the enclosure and the plurality of acoustic receivers.
   A2. The downhole acoustic tool of A1, wherein the plurality of acoustic receivers are positioned around the tool body around a circumference of at least some of the plurality of mass bodies.
   A3. The downhole acoustic tool of any of A1 or A2, wherein the plurality of mass bodies includes at least two mass bodies and the plurality of acoustic receivers includes at least 4 acoustic receivers positioned around each of the at least two mass bodies.
   A4. The downhole acoustic tool of any of A1-A3, wherein the plurality of acoustic receivers comprise a first array of at least eight acoustic receivers positioned around the tool body at a first longitudinal position of the tool body.
   A5. The downhole acoustic tool of A4, further comprising a second plurality of acoustic receivers comprising a second array of at least eight acoustic receivers positioned around the tool body at a second longitudinal position of the tool body, wherein the enclosure is positioned surrounding the first array and the second array of acoustic receivers.
   A6. The downhole acoustic tool of A5, wherein a first acoustic receiver of the first array of acoustic receivers and a second acoustic receiver of the second array of acoustic receivers are both positioned on a printed wiring assembly (PWA), wherein the PWA is connected to the tool body at two or more of the plurality of mass bodies.
   A7. The downhole acoustic tool of any of A1-A6, wherein the enclosure is sized to be implemented within a tubular having a diameter of 6 inches or less.
   A8. The downhole acoustic tool of any of A1-A7, wherein the plurality of mass bodies and the one or more spring bodies are configured such that a flexural slowness of the acoustic body is greater than about 400.
   A9. The downhole acoustic tool of A8, wherein the flexural slowness of the acoustic body is greater than 490 μs/ft for frequencies up to 5500 Hz.
   A10. The downhole acoustic tool of any of A1-A9, wherein, for a unit length of 10.16 cm (4 inches) between adjacent mass bodies of the acoustic body, the plurality of mass bodies each have a mass length of between 5 cm and 7 cm and the one or more spring bodies each have a spring length of between 7 cm and 9 cm, wherein the plurality of mass bodies having overhanging mass sections.
   A11. The downhole acoustic tool of any of A1-A10, wherein the plurality of acoustic receivers are connected to the tool body in grooves on the plurality of mass bodies formed by a plurality of ribs extending radially from the plurality of mass bodies, and wherein the plurality of acoustic receivers are positioned in the grooves via rubber mounts configured to dampen the plurality of acoustic receivers from shocks and vibrations.
   A12. The downhole acoustic tool of any of A1-A11, wherein the enclosure is a thin-walled cannister.
   A13. The downhole acoustic tool of any of A1-A12, wherein the enclosure includes one or more flexible members for accommodating a bending of the tool body without the enclosure failing.
   A14. The downhole acoustic tool of any of A1-A13, wherein the enclosure includes a plurality of interlocking sleeves that each interlock with a sealed interface and wherein the enclosure bends at the sealed interface to accommodate a bending of the tool body without the enclosure failing.
   A15. The downhole acoustic tool of any of A1-A14, wherein the plurality of acoustic receivers are piezoelectric transducers.
   B1. A downhole acoustic tool, comprising:
a tool body;
at least one acoustic receiver positioned around an outer surface of the tool body;
an enclosure surrounding the tool body and the at least one acoustic receiver, the enclosure including:
   a flexible member positioned around the tool body and covering the at least one acoustic receiver; and
   a protective member positioned around the flexible member; and
an acoustic fluid contained within the enclosure, at least some of the acoustic fluid being positioned between an inner surface of the enclosure and the at least one acoustic receiver.
   B2. The downhole acoustic tool of B1, wherein the protective member is supported by the tool body to prevent loading on the flexible member by transferring lateral forces on the protective member to the tool body.
   B2. The downhole acoustic tool of any of B1 or B2, wherein the flexible member includes a metallic bellows for containing the acoustic fluid within the enclosure while accommodating bending of the tool body.
   B3. The downhole acoustic tool of any of B1-B3, further including a coupler for connecting the protective member to the tool body, wherein the flexible member is sealed to the coupler for containing the acoustic fluid.
   C1. A downhole system comprising:
a receiver tool, including:
   a tool body comprising an acoustic body;
   a plurality of acoustic receivers positioned around an outer surface of the tool body;
   an enclosure surrounding the tool body and the plurality of acoustic receivers; and
   an acoustic fluid contained within the enclosure, at least some of the acoustic fluid being positioned between an inner surface of the enclosure and the plurality of acoustic receivers; and
a transmission tool axially connected to the receiver tool and including at least one acoustic transmitter for transmitting one or more acoustic signals to be received by the plurality of acoustic receivers of the receiver tool,
wherein the acoustic body has a flexural slowness to prevent the one or more acoustic signals from travelling through the tool body to the plurality of acoustic receivers.
   C2. The downhole system of C1, wherein the transmission tool further includes one or more transmission amplifiers having a mass configured to prevent the at least one acoustic transmitter from exciting the one or more acoustic signals into the transmission tool, and to amplify the one or more acoustic signals being transmitted from the transmission tool.
   C3. The downhole system of C2, wherein the one or more transmission amplifiers comprise an acoustic fin for directing a first set of acoustic signals of the one or more acoustic signals in a first direction and for directing a second set of acoustic signals of the one or more acoustic signals in a second direction independent of the first set of acoustic signals.
   D1. A downhole acoustic tool, comprising:
a tool body;
at least one acoustic receiver positioned around an outer surface of the tool body;
an enclosure surrounding the tool body and the at least one acoustic receiver, the enclosure including a plurality of interlocking sleeves that interlock at a plurality of sleeve interfaces, each sleeve interface of the plurality of sleeve interfaces being formed by:
   a first connector at a first interlocking sleeve of the sleeve interface;
   a second connector at a second interlocking sleeve of the sleeve interface configured to connect to the first connector; and
   a seal between the first interlocking sleeve and the second interlocking sleeve for sealing an inner volume of the enclosure; and
an acoustic fluid contained within the enclosure, at least some of the acoustic fluid being positioned between an inner surface of the enclosure and the at least one acoustic receiver.
   D2. The downhole acoustic tool of D1, wherein the enclosure is configured to at least partially bend at the plurality of sleeve interfaces to accommodate a bending of the tool body.
   D3. The downhole acoustic tool of D2, wherein the plurality of sleeve interfaces bend based on the first interlocking sleeve of a respective sleeve interface and the second interlocking sleeve of the respective sleeve interface rotating with respect to one another based on a tolerance of the respective sleeve interface.
   D4. The downhole acoustic tool of any of D1-D3, wherein the seal is an O-ring seal.
   D5. The downhole acoustic tool of any of D1-D4, wherein each of the plurality of sleeve interfaces further includes a retainer positioned between the first interlocking sleeve and the second interlocking sleeve to prevent separation of the first interlocking sleeve from the second interlocking sleeve.
   D6. The downhole acoustic tool of any of D1-D5, wherein each interlocking sleeve of the plurality of interlocking sleeves includes an acoustic window having a material thickness of between 0.8 mm and 3.6 mm.
   D7. The downhole acoustic tool of D6, wherein the at least one acoustic receiver is positioned at the acoustic window of an associated interlocking sleeve.
   D8. The downhole acoustic tool of any of D1-D7, further comprising a plurality of acoustic receivers positioned at a plurality of longitudinal locations along the tool body, and an interlocking sleeve of the plurality of interlocking sleeves is positioned at each of the plurality of longitudinal locations.
   D9. The downhole acoustic tool of any of D1-D8, wherein the first connector includes a pin on an inner surface of the first interlocking sleeve and the second connector includes a J slot on an outer surface of the second interlocking sleeve.
   D10. The downhole acoustic tool of any of D1-D9, wherein each sleeve interface of the plurality of sleeve interfaces includes two first connectors on the first interlocking sleeve configured to connect to two second connectors on the second interlocking sleeve.
   D11. The downhole acoustic tool of any of D1-D10, further comprising twelve arrays of acoustic receivers positioned at twelve longitudinal locations along the tool body, each array including eight acoustic receivers positioned around the outer surface of the tool body, wherein the plurality of interlocking sleeves includes twelve interlocking sleeves positioned at the twelve longitudinal locations to form the enclosure.
   E1. A method of assembling a downhole acoustic tool, comprising:
providing a tool body having at least one acoustic receiver positioned around an outer surface of the tool body; and
forming an enclosure around the tool body, including:
   positioning a first interlocking sleeve of a plurality of interlocking sleeves around the tool body at a longitudinal location of the tool body of a first acoustic receiver of the at least one acoustic receiver;
   positioning a second interlocking sleeve of the plurality of interlocking sleeves around the tool body; and
   connecting the first interlocking sleeve to the second interlocking sleeve by engaging a first connector of the first interlocking sleeve with a second connector of the second interlocking sleeve to seal an inner volume of the enclosure.
      E2. The method of claim E1, further comprising filling the enclosure with an acoustic fluid such that at least some of the acoustic fluid is positioned between an inner surface of the enclosure and the at least one acoustic receiver.
      E3. The method of any of E1 or E2, further comprising rotating the first interlocking sleeve with the second interlocking sleeve to engage the first connector with the second connector.
      E4. The method of any of E1-E3, further comprising positioning a seal between the first interlocking sleeve and the second interlocking sleeve to seal the inner volume of the enclosure.
      E5. The method of any of E1-E4, wherein the plurality of interlocking sleeves each include an acoustic window, the method further comprising aligning the acoustic window of the first interlocking sleeve with the first acoustic receiver.
      E6. The method of any of E1-E5, further comprising bending the enclosure at a sleeve interface between the first interlocking sleeve and the second interlocking sleeve based on a tolerance of the sleeve interface to accommodate a bending of the tool body.
      E7. The method of any of E1-E6, wherein the downhole acoustic tool includes twelve acoustic sensors positioned at twelve longitudinal locations along the tool body, the method further comprising forming the enclosure from twelve interlocking sleeves including:
positioning the twelve interlocking sleeves at the twelve longitudinal locations; and
connecting the twelve interlocking sleeves based on engaging first and second connectors of adjacent interlocking sleeves of the twelve interlocking sleeves to seal the inner volume of the enclosure.

The embodiments of the acoustic tools have been primarily described with reference to wellbore drilling operations; the acoustic tools described herein may be used in applications other than the drilling of a wellbore. In other embodiments, the acoustic tools according to the present disclosure may be used outside a wellbore or other downhole environment used for the exploration or production of natural resources. For instance, the acoustic tools of the present disclosure may be used in a borehole used for placement of utility lines. Accordingly, the terms “wellbore,” “borehole” and the like should not be interpreted to limit tools, systems, assemblies, or methods of the present disclosure to any particular industry, field, or environment.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements. Additionally, as used herein, the term “and/or” includes any and all combinations of one or more of the associated listed items.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A downhole acoustic tool, comprising:
a tool body comprising a plurality of mass bodies connected via one or more spring bodies for forming an acoustic body;
a plurality of acoustic receivers positioned around the tool body on at least some of the plurality of mass bodies;
an enclosure surrounding the tool body and the plurality of acoustic receivers; and
an acoustic fluid contained within the enclosure, at least some of the acoustic fluid being positioned between an inner surface of the enclosure and the plurality of acoustic receivers.

2. The downhole acoustic tool of claim 1, wherein the plurality of acoustic receivers are positioned around the tool body around a circumference of at least some of the plurality of mass bodies.

3. The downhole acoustic tool of claim 1, wherein the plurality of acoustic receivers comprise a first array of at least eight acoustic receivers positioned around the tool body at a first longitudinal position of the tool body.

4. The downhole acoustic tool of claim 3, further comprising a second plurality of acoustic receivers comprising a second array of at least eight acoustic receivers positioned around the tool body at a second longitudinal position of the tool body, wherein the enclosure is positioned surrounding the first array and the second array of acoustic receivers.

5. The downhole acoustic tool of claim 4, wherein a first acoustic receiver of the first array of acoustic receivers and a second acoustic receiver of the second array of acoustic receivers are both positioned on a printed wiring assembly (PWA), wherein the PWA is connected to the tool body at two or more of the plurality of mass bodies.

6. The downhole acoustic tool of claim 1, wherein the enclosure is sized to be implemented within a tubular having a diameter of 6 inches or less.

7. The downhole acoustic tool of claim 1, wherein the plurality of mass bodies and the one or more spring bodies are configured such that a flexural slowness of the acoustic body is greater than about 400.

8. The downhole acoustic tool of claim 1, wherein the enclosure includes a plurality of interlocking sleeves that each interlock with a sealed interface and wherein the enclosure bends at the sealed interface to accommodate a bending of the tool body without the enclosure failing.

9. A downhole acoustic tool, comprising:
a tool body;
at least one acoustic receiver positioned around an outer surface of the tool body;
an enclosure surrounding the tool body and the at least one acoustic receiver, the enclosure including a plurality of interlocking sleeves that interlock at a plurality of sleeve interfaces, each sleeve interface of the plurality of sleeve interfaces being formed by:
a first connector at a first interlocking sleeve of the sleeve interface;
a second connector at a second interlocking sleeve of the sleeve interface configured to connect to the first connector; and
a seal between the first interlocking sleeve and the second interlocking sleeve for sealing an inner volume of the enclosure; and
an acoustic fluid contained within the enclosure, at least some of the acoustic fluid being positioned between an inner surface of the enclosure and the at least one acoustic receiver.

10. The downhole acoustic tool of claim 9, wherein the enclosure is configured to at least partially bend at the plurality of sleeve interfaces to accommodate a bending of the tool body.

11. The downhole acoustic tool of claim 10, wherein the plurality of sleeve interfaces bend based on the first interlocking sleeve of a respective sleeve interface and the second interlocking sleeve of the respective sleeve interface rotating with respect to one another based on a tolerance of the respective sleeve interface.

12. The downhole acoustic tool of claim 9, wherein each interlocking sleeve of the plurality of interlocking sleeves includes an acoustic window having a material thickness of between 0.8 mm and 3.6 mm, and wherein the at least one acoustic receiver is positioned at the acoustic window of an associated interlocking sleeve.

13. The downhole acoustic tool of claim 9, further comprising a plurality of acoustic receivers positioned at a plurality of longitudinal locations along the tool body, and an interlocking sleeve of the plurality of interlocking sleeves is positioned at each of the plurality of longitudinal locations.

14. The downhole acoustic tool of claim 9, wherein the first connector includes a pin on an inner surface of the first interlocking sleeve and the second connector includes a J slot on an outer surface of the second interlocking sleeve.

15. A method of assembling a downhole acoustic tool, comprising:
providing a tool body having at least one acoustic receiver positioned around an outer surface of the tool body; and
forming an enclosure around the tool body, including:
positioning a first interlocking sleeve of a plurality of interlocking sleeves around the tool body at a longitudinal location of the tool body of a first acoustic receiver of the at least one acoustic receiver;
positioning a second interlocking sleeve of the plurality of interlocking sleeves around the tool body; and
connecting the first interlocking sleeve to the second interlocking sleeve by engaging a first connector of the first interlocking sleeve with a second connector of the second interlocking sleeve to seal an inner volume of the enclosure.

16. The method of claim 15, further comprising filling the enclosure with an acoustic fluid such that at least some of the acoustic fluid is positioned between an inner surface of the enclosure and the at least one acoustic receiver.

17. The method of claim 15, further comprising rotating the first interlocking sleeve with the second interlocking sleeve to engage the first connector with the second connector.

18. The method of claim 15, wherein the plurality of interlocking sleeves each include an acoustic window, the method further comprising aligning the acoustic window of the first interlocking sleeve with the first acoustic receiver.

19. The method of claim 15, further comprising bending the enclosure at a sleeve interface between the first interlocking sleeve and the second interlocking sleeve based on a tolerance of the sleeve interface to accommodate a bending of the tool body.

20. The method of claim 15, wherein the downhole acoustic tool includes twelve acoustic sensors positioned at twelve longitudinal locations along the tool body, the method further comprising forming the enclosure from twelve interlocking sleeves including:
positioning the twelve interlocking sleeves at the twelve longitudinal locations; and
connecting the twelve interlocking sleeves based on engaging first and second connectors of adjacent interlocking sleeves of the twelve interlocking sleeves to seal the inner volume of the enclosure.
